(19) United States
(12) Patent Application Publication
(10) Pub. No.: US 2003/0004236 A1
(43) Pub. Date: Jan. 2, 2003

(54) Magnetic resonance imaging agents for detection and delivery of therapeutic agents and detection of physiological substances

(76) Inventor: Thomas J. Meade, Alta Dena, CA (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 10/128,131

(22) Filed: Apr. 22, 2002

Related U.S. Application Data
(60) Provisional application No. 60/285,602, filed on Apr. 20, 2001.

(51) Int. Cl. C08K 5/34

(52) U.S. Cl. 524/98

(57) ABSTRACT

The invention relates to magnetic resonance imaging moieties, having increased in vivo residence time and amplified MRI signal, comprising a polymer and a plurality of activatable magnetic resonance imaging contrasting agents each attached to the polymer by a cleavable linkage; methods of detecting physiological signals or substances; and methods of drug delivery and drug detection for treatment of diseases.

This application claims the benefit of provisional application Ser. No. 60/285,602, filed Apr. 20, 2001.

### FIELD OF THE INVENTION

The invention relates to magnetic resonance imaging moieties, having increased in vivo residence time and amplified MRI signal, comprising a polymer and a plurality of activatable magnetic resonance imaging contrasting agents each attached to the polymer by a cleavable linkage; methods of detecting physiological signals or substances; and methods of drug delivery and drug detection for treatment of diseases.

### BACKGROUND OF THE INVENTION

Magnetic resonance imaging (MRI) is a diagnostic and research procedure that uses high magnetic fields and radio-frequency signals to produce images. The most abundant molecular species in biological tissues is water. It is the quantum mechanical “spin” of the water proton nuclei that ultimately gives rise to the signal in all imaging experiments. In MRI the sample to be imaged is placed in a strong static magnetic field (1-12 Tesla) and the spins are excited with a pulse of radio frequency (RF) radiation to produce a net magnetization in the sample. Various magnetic field gradients and other RF pulses then act on the spins to code spatial information into the recorded signals. MRI is able to generate structural information in three dimensions in relatively short time spans.

The Image.

MR images are typically displayed on a gray scale with black the lowest and white the highest measured intensity (I). This measured intensity I=C*M, where C is the concentration of spins (in this case, water concentration) and M is a measure of the magnetization present at time of the measurement. Although variations in water concentration (C) can give rise to contrast in MR images, it is the strong dependence of the rate of change of M on local environment that is the source of image intensity variation in MRI. Two characteristic relaxation times, T₁ & T₂, govern the rate at which the magnetization can be accurately measured. T₁ is the exponential time constant for the spins to decay back to equilibrium after being perturbed by the RF pulse. In order to increase the signal-to-noise ratio (SNR) a typical MR imaging scan (RF & gradient pulse sequence and data acquisition) is repeated at a constant rate for a predetermined number of times and the data averaged. The signal amplitude recorded for any given scan is proportional to the number of spins that have decayed back to equilibrium since the previous scan. Thus, regions with rapidly decaying spins (i.e. short T₁ values) will recover all of their signal amplitude between successive scans.

The measured intensities in the final image will accurately reflect the spin density (i.e. water content). Regions with long T₁ values compared to the time between scans will progressively lose signal until a steady state condition is reached and will appear as darker regions in the final image. Changes in T₂ (spin-spin relaxation time) result in changes in the signal linewidth (shorter T₂ values) yielding larger linewidths. In extreme situations the linewidth can be so large that the signal is indistinguishable from background noise. In clinical imaging, water relaxation characteristics vary from tissue to tissue, providing the contrast which allows the discrimination of tissue types. Moreover, the MRI experiment can be setup so that regions of the sample with short T₁ values and/or long T₂ values are preferentially enhanced so called T₁-weighted and T₂-weighted imaging protocol.

MRI Contrast Agents.

There is a rapidly growing body of literature demonstrating the clinical effectiveness of paramagnetic contrast agents (currently 8 are in clinical trials or in use). The capacity to differentiate regions/tissues that may be magnetically similar but histologically distinct is a major impetus for the preparation of these agents. In the design of MRI contrast agents, strict attention must be given to a variety of properties that will ultimately effect the physiological outcome apart from the ability to provide contrast enhancement. Two fundamental properties that must be considered are biocompatability and proton relaxation enhancement. Biocompatability is influenced by several factors including toxicity, stability (thermodynamic and kinetic), pharmacokinetics and biodistribution. Proton relaxation enhancement (or relaxivity) is chiefly governed by the choice of metal and rotational correlation times.

The first feature to be considered during the design stage is the selection of the metal atom, which will dominate the measured relaxivity of the complex. Paramagnetic metal ions, as a result of their unpaired electrons, act as potent relaxation enhancement agents. They decrease the T₁ and T₂ relaxation times of nearby (r⁶ dependence) spins. Some paramagnetic ions decrease the T₁ without causing substantial linebroadening (e.g. gadolinium (III), (Gd³⁺)), while others induce drastic linebroadening (e.g. superparamagnetic iron oxide). The mechanism of T₁ relaxation is generally a through space dipole-dipole interaction between the unpaired electrons of the paramagnet (the metal atom with an unpaired electron) and bulk water molecules (water molecules that are not “bound” to the metal atom) that are in fast exchange with water molecules in the metal's inner coordination sphere (are bound to the metal atom).

For example, regions associated with a Gd³⁺ ion (near-by water molecules) appear bright in an MR image where the normal aqueous solution appears as dark background if the time between successive scans in the experiment is short (i.e. T₁ weighted image). Localized T₂ shortening caused by superparamagnetic particles is believed to be due to the local magnetic field inhomogeneities associated with the large magnetic moments of these particles. Regions associated with a superparamagnetic iron oxide particle appear dark in an MR image where the normal aqueous solution appears as high intensity background if the echo time (TE) in the spin-echo pulse sequence experiment is long (i.e. T₂-weighted image). The lanthanide atom Gd³⁺ is by the far the most frequently chosen metal atom for MRI contrast agents because it has a very high magnetic moment (u²=63BM²), and a symmetric electronic ground state (S⁸). Transition metals such as high spin Mn(II) and Fe(III) are also candidates due to their high magnetic moments.

Once the appropriate metal has been selected, a suitable ligand or chelate must be found to render the complex nontoxic. The term chelator is derived from the Greek word chele which means a “crabs claw”, an appropriate description for a material that uses its many “arms” to grab and hold on to a metal atom (see DTPA below). Several factors influence the stability of chelate complexes include enthalpy and entropy effects (e.g. number, charge and basicity of coordinating groups, ligand field and conformational effects). Various molecular design features of the ligand can be directly correlated with physiological results. For example, the presence of a single methyl group on a given ligand structure can have a pronounced effect on clearance rate. While the addition of a bromine group can force a given complex from a purely extracellular role to an effective agent that collects in hepatocytes.

Diethylenetriaminepentaacetic (DTPA) chelates and thus acts to detoxify lanthanide ions. The stability constant (K) for Gd(DTPA) ²⁻ is very high (logK=22.4) and is more commonly known as the formation constant (the higher the logK, the more stable the complex). This thermodynamic parameter indicates the fraction of Gd³⁺ ions that are in the unbound state will be quite small and should not be confused with the rate (kinetic stability) at which the loss of metal occurs (k_{f}/k_{d}). The water soluble Gd(DTPA)²⁻ chelate is stable, nontoxic, and one of the most widely used contrast enhancement agents in experimental and clinical imaging research. It was approved for clinical use in adult patients in June of 1988. It is an extracellular agent that accumulates in tissue by perfusion dominated processes.

To date, a number of chelators have been used, including diethylenetriaminepentaacetic (DTPA), 1,4,7,10-tetraazacyclododecane′-N,N′N″,N′″-tetracetic acid (DOTA), and derivatives thereof. See U.S. Pat. Nos. 5,155,215, 5,087,440, 5,219,553, 5,188,816, 4,885,363, 5,358,704, 5,262,532, and Meyer et al., Invest. Radiol. 25: S53 (1990).

Image enhancement improvements using Gd(DTPA) are well documented in a number of applications (Runge et al., Magn, Reson. Imag. 3:85 (1991); Russell et al., AJR 152:813 (1989); Meyer et al., Invest. Radiol. 25:S53 (1990)) including visualizing blood-brain barrier disruptions caused by space occupying lesions and detection of abnormal vascularity. It has recently been applied to the functional mapping of the human visual cortex by defining regional cerebral hemodynamics (Belliveau et al., (1991) 254:719).

Another chelator used in Gd contrast agents is the macrocyclic ligand 1,4,7,10-tetraazacyclododecane-N,N′,N″N′″-tetracetic acid (DOTA). The Gd-DOTA complex has been thoroughly studied in laboratory tests involving animals and humans. The complex is conformationally rigid, has an extremely high formation constant (logk=28.5), and at physiological pH possess very slow dissociation kinetics. Recently, the GdDOTA complex was approved as an MRI set off agent for use in adults and infants in France and has been administered to over 4500 patients.

In addition, another class of chelators has been described in U.S. Pat. Nos. 5,624,901, 5,892,029, WO 97/00245, and Cohen et al., lnorg. Chem. 39:5747 (2000).

Further, previous work has resulted in MRI contrast agents that report on physiologic or metabolic processes within a biological or other type of sample. As described in U.S. Pat. No. 5,707,605, U.S. Pat. No. 5,980,862, PCT US96/08549, and U.S. Ser. No. 09/134,072, MRI contrast agents have been constructed that allow an increase in contrast as a result of the interaction of a blocking moiety present on the agent with a target substance. That is, in the presence of the target substance, the exchange of water in one or more inner sphere coordination sites of the contrast agent is increased, leading to a brighter signal; in the absence of the target substance, the exchange of water is hindered and the image remains dark. Thus, the previous work enables imaging of physiological events rather than just structure.

As noted above, these MRI contrast agents have a variety of uses. However, a limitation of currently approved MRI contrast agents is their vascular or in vivo residence time. A further limitation is the ability to deliver therapeutic agents and follow the therapeutic agents via MRI after their delivery. Accordingly, it is an object of the present invention to provide imaging moieties, comprising a plurality of MRI contrast agents, that have increased in vivo residence time and allow the detection of physiological substances and delivery and detection of therapeutic agents within an animal, tissue or cell.

### SUMMARY OF THE INVENTION

In accordance with the above objects, the invention provides magnetic resonance imaging moieties, having increased in vivo residence time and amplified MRI signal, comprising a polymer and a plurality of activatable magnetic resonance imaging contrasting agents each attached to the polymer by a cleavable linkage; methods of detecting physiological signals or substances; and methods of drug delivery and drug detection for treatment of diseases. The cleavable linkage can be, for example, an esterase linkage. Moreover, the MRI contrast agent or polymer can further comprise a targeting moiety. Further, the blocking moiety can be a therapeutic blocking moiety.

In one aspect, the invention provides imaging moieties comprising a polymer and a plurality of MRI contrast agents each linked to the polymer by a cleavable linkage, wherein at least one of the MRI contrast agents comprises: a) a paramagnetic metal ion capable of binding n coordination atoms, wherein the metal ion is bound to a chelator such that the metal ion has coordination atoms at (n-1) or (n-2) coordination sites of the metal ion; and b) a blocking moiety covalently attached to the chelator which hinders the rapid exchange of water in the remaining coordination site or sites; wherein the blocking moiety is capable of interacting with a target substance such that the exchange of water in the remaining coordination sites is increased.

In a further aspect, at least one of the MRI contrast agents has the formula:

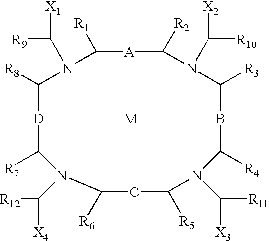

wherein M is a paramagnetic metal ion selected from the group consisting of Gd(III), Fe(III), Mn(II), Yt(III), Cr(III) and Dy(IlI); A, B, C and D are either single bonds or double bonds; X₁, X₂, X₃ and X₄ are —OH, —COO—, —CH₂OH—CH₂COO—, or a blocking moiety; R₁-R₁₂ each comprise a hydrogen, alkyl, aryl, alcohol, amine, amido, nitro, ether, ester, ketone, imino, aldehyde, alkoxy, carbonyl, halogen, sulfur containing moiety, phosphorus containing moiety, blocking moiety, targeting moiety, or, together with an adjacent R group comprise an alkyl or aryl group; wherein at least one of R₁-R₁₂ further comprises the cleavable linkage; and wherein at least one of X₁-X₄ and R₁-R₁₂ is a blocking moiety.

Also in a further aspect, at least one of the MRI contrast agents has the formula:

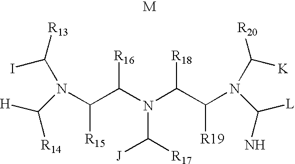

wherein M is a paramagnetic metal ion selected from the group consisting of Gd(III), Fe(III), Mn(II), Yt(III), Cr(III) or Dy(III); H, I, J, K and L are —OH, —COO—, —CH2OH, —CH2COO—, or a blocking moiety; R₁₃-R₂₁ each comprise a hydrogen, alkyl, aryl, alcohol, amine, amido, nitro, ether, ester, ketone, imino, aldehyde, alkoxy, carbonyl, halogen, sulfur containing moiety, phosphorus containing moiety, blocking moiety, targeting moiety, or, together with an adjacent R group comprise an alkyl or aryl group; wherein at least one of R₁₃-R₂₁, H, I, J, K or L is a blocking moiety; and wherein at least one of R₁-R₁₂ comprise the cleavable linkage.

In another aspect, the invention provides imaging moieties comprising a polymer and a plurality of MRI contrast agents each linked to the polymer by a cleavable linker, and wherein at least one of the MRI contrast agents comprises: a) at least a first paramagnetic metal ion bound to a first complex, the first complex comprising: i) a first chelator; and ii) a blocking moiety covalently attached to the first chelator which binds in at least a first coordination site of the first metal ion and which is capable of interacting with a target substance such that the exchange of water in at least the first coordination site of the first metal ion is increased; and b) at least a second paramagnetic metal ion bound to a second complex, the second complex comprising: i) a second chelator; and ii) a blocking moiety covalently attached to the second chelator which binds in at least a first coordination site of the second metal ion and which is capable of interacting with a target substance such that the exchange of water in at least the first coordination site of the second metal ion is increased.

In another aspect, the invention provides imaging moieties comprising a polymer and a plurality of MRI contrast agents each linked to the polymer by a cleavable linker, wherein at least one of the MRI contrast agents comprises at least a first MRI duplex moiety, the MRI duplex moiety comprising: a) a first chelator comprising a first paramagnetic metal ion; b) a second chelator comprising a second paramagnetic metal ion; c) a blocking moiety covalently attached to at least one of the first or the second chelators, the blocking moiety providing at least a first coordination atom of each of the first and the second metal ions and which is capable of interacting with a target substance such that the exchange of water in at least a first coordination site in at least one of the metal ions is increased.

In another aspect, the invention provides imaging moieties comprising a polymer and a plurality of MRI contrast agents each linked to the polymer by a cleavable linker, and wherein at least one of the MRI contrast agents comprises a paramagnetic metal ion bound to a complex, the complex comprising: a) a chelator; and b) a blocking moiety covalently attached to the chelator which binds in at least a first coordination site of the metal ion and which is capable of interacting with a target substance such that the exchange of water in at least the first coordination site is increased.

### BRIEF DESCRIPTION OF THE DRAWINGS

FIGS. 1A-D depict examples of imaging moieties of the present invention comprising a polymer and a plurality of MRI contrast agents attached to the polymer by a cleavable linker. CL=cleavable linker; BM=blocking moiety; TM=targeting moiety; M=paramagnetic ion; n is an integer of 1 or greater; and m is an integer of 0 or greater. CL is cleavable linker that either contributes a coordination atom, thereby serving as a blocking moiety (BM); or serves as a coordination site barrier.

FIG. 2 depicts a preferred embodiment of the invention, using a single chelate with a single blocking moiety, attached to a dextran-type polymer with amine functionalities to allow attachment, although as will be appreciated by those in the art, other heteroatoms and functional groups can be used. The enzyme cleavable site or cleavable linkage can include any number of cleavage sites as outlined herein, including protease cleavage sites as well as ester linkages. In addition as depicted in FIGS. 2, 3 and 4, the DOTA-based MRI agent depicted utilizes a “non-arm” R group for attachment to the polymer, although other positions, as well as other chelates, may be used. In addition, the chelate does not depict all possible R groups, and the gadolinium metal ion, although again, other chelate/metal combinations may be used. In addition, as outlined herein, other polymers can be used.

FIG. 3 is similar to FIG. 2, except nitrogens are used in the linker.

FIG. 4 depicts a situation where the cleavable site actually serves as a blocking moiety, providing either a coordination atom or a coordination site barrier. Again, all R groups are not shown, and other metal/chelate pairs in addition to Gd/DOTA may be used.

### DETAILED DESCRIPTION OF THE INVENTION

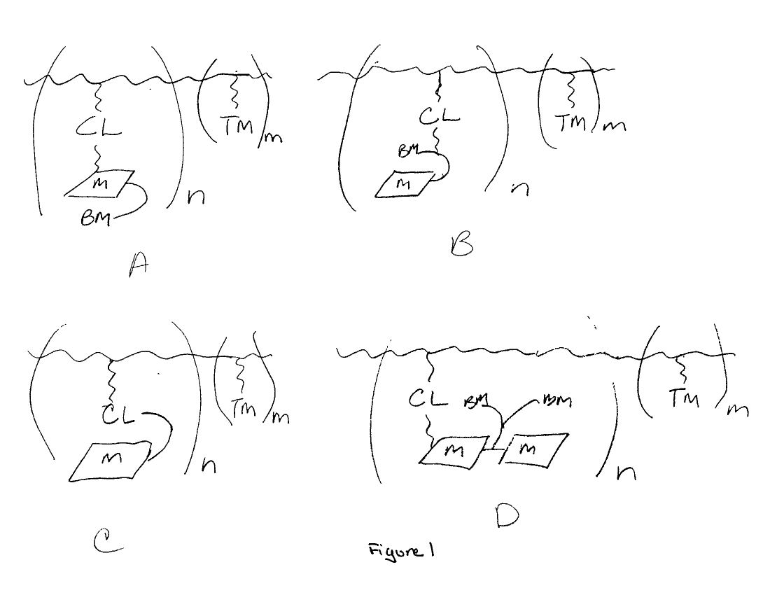

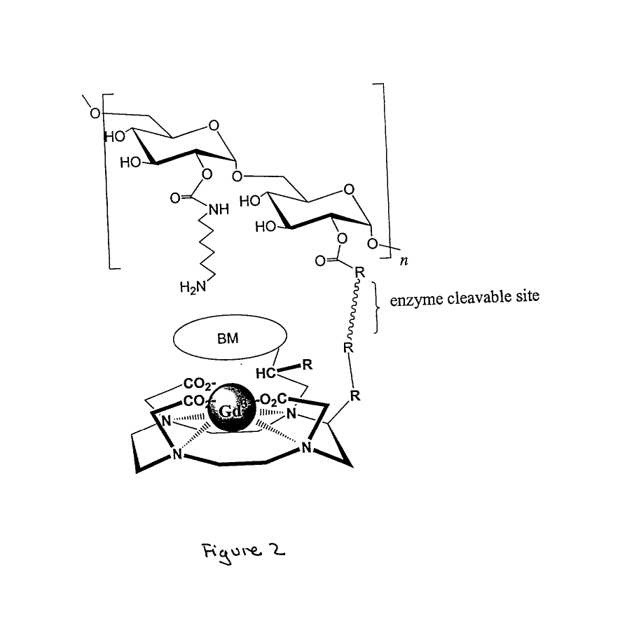

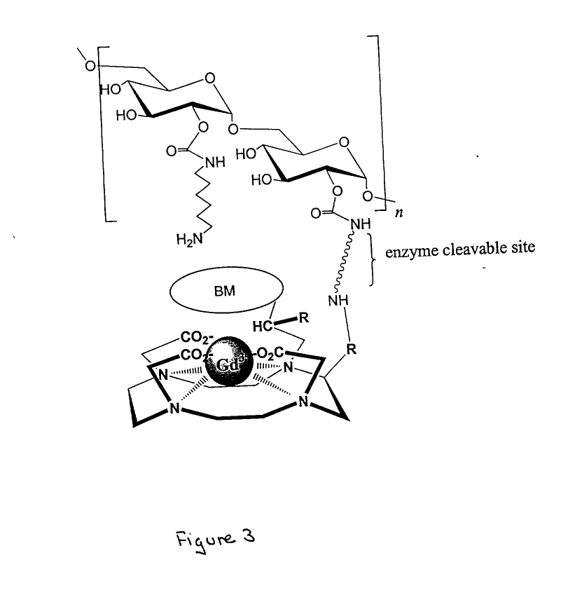

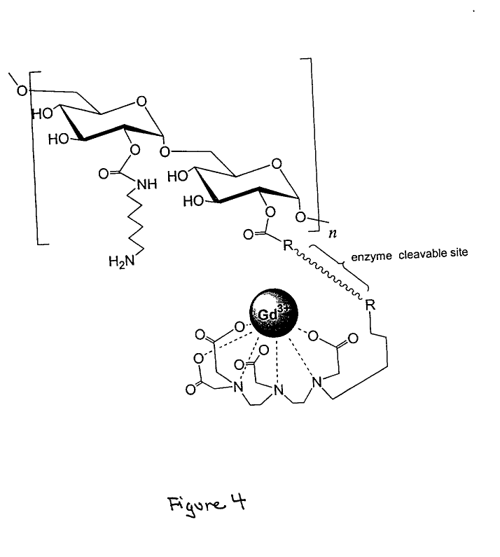

The present invention provides magnetic resonance imaging (MRI) contrast moieties having increased in vivo residence time and amplified MRI signal. The imaging moieties comprise a polymer and a plurality of activatable MRI contrast agents each linked to the polymer by a cleavable linkage (see, e.g., FIGS. 1-4). In the absence of a physiological target substance, the MRI contrast agents of the invention are relatively inactive, or have weak relaxivity, as contrast enhancement agents. However, in the presence of the physiological or target substance, the MRI contrast agents of the invention are activated and, thereby, alter the MR image. See U.S. Pat. No. 5,707,605 and U.S. Pat. No. 5,980,862, and U.S. Ser. No. 09/866,512, each expressly incorporated herein by reference.

The advantages of the image moieties of the present invention is their increased in vivo residence time and amplified MRI signal. The imaging moieties comprise a polymer and a plurality of MRI contrast agents each linked to the polymer by a cleavable linkage. The cleavable linkage is cleaved in the presence of a physiological or target substance. Thus, the MRI contrast agents can be slowly removed or cleaved from the polymer backbone. The cleavable linkage includes any number of cleavage linkages or sites as outlined herein, including protease cleavage sites as well as ester linkages.

The imaging moieties can also detect the delivery of therapeutically active agents (e.g., drugs) as a result of an interaction of a physiological target agent and the MRI contrast agents of the imaging moieties. The MRI contrast agents of the invention are relatively inactive, or have weak relaxivity, as contrast enhancement agents in the absence of the physiological target substance, and are activated, thus altering the MR image, upon the delivery of the therapeutically active agent.

The imaging of the delivery of the target physiological substance can occur in two basic ways. In one embodiment, it is the actual interaction of the blocking moiety with its target that causes the MRI contrast agent to turn “on”, as described below; that is, as a result of the presence of the physiological target, the MRI contrast agent undergoes a reorganization that can include the cleavage of the blocking moiety off the remainder of MRI contrast agent, causing an increase in signal as a result of an increase in the exchange of water in an inner coordination site. Alternatively, it is the delivery event of the blocking moiety that is imaged; that is, the blocking moiety is cleaved off of the MRI contrast agent as a result of exposure to a cleavage agent such as a protease, freeing the blocking moiety to interact with its target. In general, it is the former that is discussed herein, although as will be appreciated by those in the art, either possibility can occur.

Viewed simplistically, this “trigger” mechanism, whereby the contrast agent is “turned on” (i.e. increases the relaxivity) is based on a dynamic equilibrium that affects the rate of exchange of water molecules in one or more coordination sites of a paramagnetic metal ion contained in the MRI contrast agents of the imaging moieties of the present invention. In turn, the rate of exchange of the water molecule is determined by the presence or absence of the therapeutic blocking moiety on the MRI contrast agent. Thus, for example, in the presence of the therapeutically active agent, the metal ion complexes of the invention which chelate the paramagnetic ion have reduced coordination sites available which can rapidly exchange with the water molecules of the local environment. Also, for example, in the absence of the target substance, the metal ion complexes of the invention which chelate the paramagnetic ion have reduced coordination sites available which can rapidly exchange with the water molecules of the local environment. In such a situation, the water coordination sites are substantially occupied or blocked by the coordination atoms of the chelator and at least one therapeutic blocking moiety. Thus, the paramagnetic ion has essentially no water molecules in its “inner-coordination sphere”, i.e., actually bound to the metal when the target substance is absent. It is the interaction of the paramagnetic metal ion with the protons on the inner coordination sphere water molecules and the rapid exchange of such water molecules that cause the high observed relaxivity, and thus the imaging effect, of the paramagnetic metal ion. Accordingly, if all the coordination sites of the metal ion in the metal ion complex are occupied with moieties other than water molecules, for example, when the therapeutic blocking moiety is present, there is little if any net enhancement of the imaging signal by the metal ion complexes of the invention. However, when the therapeutically active agent is removed (for example, either as a result of an interaction with its physiological target or by cleavage), this effectively frees at least one of the inner-sphere coordination sites on the metal ion complex. The water molecules of the local environment are then available to reversibly occupy the inner-sphere coordination site or sites, which will cause an increase in the rate of exchange of water and relaxivity of the metal ion complex toward water thereby producing image enhancement which is a measure of the delivery of the therapeutically active agent or measure of the presence of the target substance.

It should be understood that even in the absence of the target substance, at any particular coordination site, there will be a dynamic equilibrium for one or more coordination sites as between a coordination atom of the blocking moiety and water molecules. That is, even when a coordination atom is tightly bound to the metal, there will be some exchange of water molecules at the site. However, in most instances, this exchange of water molecules is neither rapid nor significant, and does not result in significant image enhancement. However, upon exposure to the target substance, the blocking moiety dislodges from the coordination site and the exchange of water is increased, i.e. rapid exchange and therefore an increase in relaxivity may occur, with significant image enhancement.

Generally, a 2 to 5% change in the MRI signal used to generate the image is sufficient to be detectable. Thus, it is preferred that the agents of the invention in the presence of a target substance increase the MRI signal by at least 2 to 5% as compared to the signal gain the absence of the target substance. Signal enhancement of 2 to 90% is preferred, and 10 to 50% is more preferred for each coordination site made available by the target substance interaction with the blocking moiety. That is, when the blocking moiety occupies two or more coordination sites, the release of the blocking moiety can result in double the increase in signal or more as compared to a single coordination site.

In addition, the compounds of the invention may also utilize targeting moieties attached to these activatable MRI contrast agents. By utilizing a targeting moiety, defined below, that can direct the MRI contrast agent to a particular cell type, tissue, or location, the MRI contrast agents of the invention become more effective, discriminatory and selective.

It should be understood that even in the absence of the target substance, at any particular coordination site, there will be a dynamic equilibrium for one or more coordination sites as between a coordination atom of the blocking moiety and water molecules. That is, even when a coordination atom is tightly bound to the metal, there will be some exchange of water molecules at the site. However, in most instances, this exchange of water molecules is neither rapid nor significant, and does not result in significant image enhancement. However, upon exposure to the target substance, the blocking moiety dislodges from the coordination site and the exchange of water is increased, i.e. rapid exchange and therefore an increase in relaxivity may occur, with significant image enhancement

See generally U.S. Pat. Nos. 5,707,605 and 5,980,862; U.S. Ser. No. 09/405,046, filed Sep. 27, 1999; U.S. Ser. No. 60/287,619, filed May 26, 2000; U.S. Ser. No. 09/179,927, filed Oct. 27, 1998; U.S. Ser. No. 60/201,817, filed May 4, 2000; U.S. Ser. No. 60/203,224, filed Jun. 6, 2000; U.S. Ser. No. 60/202,108, filed May 4, 2000; WO 01/52906, filed Jan. 22, 2001; and WO 01/08712, filed Jul. 28, 2000, all of which is expressly incorporated herein by reference.

The complexes of the invention comprise a chelator and a blocking moiety. See for example U.S. Ser. No. 10/116,706, U.S. Ser. No. 09/866,512; U.S. Ser. No. 09/972,302; U.S. Ser. No. 09/908,436, U.S. Ser. No. 09/715,859, PCT application Ser. No. PCT/US01114665, and U.S. patent application entitled “Novel Macrocyclic Activatible Magnetic Resonance Imaging Contrast Agents,” by inventor Thomas J. Meade, filed Apr. 22, 2002, all of which are expressly incorporated by reference herein.

Accordingly, the MRI contrast agents of the invention comprise a metal ion complex. The metal ion complexes of the invention comprise a paramagnetic metal ion bound to a complex comprising a chelator and a blocking moiety. By “paramagnetic metal ion”, “paramagnetic ion” or “metal ion” herein is meant a metal ion which is magnetized parallel or antiparallel to a magnetic field to an extent proportional to the field. Generally, these are metal ions which have unpaired electrons; this is a term understood in the art. Examples of suitable paramagnetic metal ions, include, but are not limited to, gadolinium III (Gd+3 or Gd(III)), iron III (Fe+3 or Fe(III)), manganese II (Mn+2 or Mn(II)), yttrium III (Yt+3 or Yt(III)), dysprosium (Dy+3 or Dy(III)), and chromium (Cr(III) or Cr+3). In a preferred embodiment the paramagnetic ion is the lanthanide atom Gd(III), due to its high magnetic moment (u²=63BM2), a symmetric electronic ground state (S8), and its current approval for diagnostic use in humans.

In addition to the metal ion, the metal ion complexes of the invention comprise a chelator and a blocking moiety which may be covalently attached to the chelator. Due to the relatively high toxicity of many of the paramagnetic ions, the ions are rendered nontoxic in physiological systems by binding to a suitable chelator. Thus, the substitution of blocking moieties in coordination sites of the chelator, which in the presence of the target substance are capable of vacating the coordination sites in favor of water molecules, may render the metal ion complex more toxic by decreasing the half-life of dissociation for the metal ion complex. Thus, in a preferred embodiment, only a single coordination site is occupied or blocked by a blocking moiety. However, for some applications, e.g. analysis of tissue and the like, the toxicity of the metal ion complexes may not be of paramount importance. Similarly, some metal ion complexes are so stable that even the replacement of one or more additional coordination atoms with a blocking moiety does not significantly effect the half-life of dissociation. For example, DOTA, described below, when complexed with Gd(III) is extremely stable. Accordingly, when DOTA serves as the chelator, several of the coordination atoms of the chelator may be replaced with blocking moieties without a significant increase in toxicity. Additionally such an agent would potentially produce a larger signal since it has two or more coordination sites which are rapidly exchanging water with the bulk solvent.

There are a variety of factors which influence the choice and stability of the chelate metal ion complex, including enthalpy and entropy effects (e.g. number, charge and basicity of coordinating groups, ligand field and conformational effects).

In general, the chelator has a number of coordination sites containing coordination atoms which bind the metal ion. The number of coordination sites, and thus the structure of the chelator, depends on the metal ion. The chelators used in the metal ion complexes of the present invention preferably have at least one less coordination atom (n-1) than the metal ion is capable of binding (n), since at least one coordination site of the metal ion complex is occupied or blocked by a blocking moiety, as described below, to confer functionality on the metal ion complex. Thus, for example, Gd(III) may have 8 strongly associated coordination atoms or ligands and is capable of weakly binding a ninth ligand. Accordingly, suitable chelators for Gd(III) will have less than 9 coordination atoms. In a preferred embodiment, a Gd(III) chelator will have 8 coordination atoms, with a blocking moiety either occupying or blocking the remaining site in the metal ion complex. In an alternative embodiment, the chelators used in the metal ion complexes of the invention have two less coordination atoms (n-2) than the metal ion is capable of binding (n), with these coordination sites occupied by one or more blocking moieties. Thus, alternative embodiments utilize Gd(III) chelators with at least 5 coordination atoms, with at least 6 coordination atoms being preferred, at least 7 being particularly preferred, and at least 8 being especially preferred, with the blocking moiety either occupying or blocking the remaining sites. It should be appreciated that the exact structure of the chelator and blocking moiety may be difficult to determine, and thus the exact number of coordination atoms may be unclear. For example, it is possible that the chelator provide a fractional or non-integer number of coordination atoms; i.e. the chelator may provide 7.5 coordination atoms, i.e., the 8th coordination atom is on average not fully bound to the metal ion. However, the metal ion complex may still be functional, if the 8th coordination atom is sufficiently bound to prevent the rapid exchange of water at the site, and/or the blocking moiety impedes the rapid exchange of water at the site.

There are a large number of known macrocyclic chelators or ligands which are used to chelate lanthanide and paramagnetic ions. See for example, Alexander, Chem. Rev. 95:273-342 (1995) and Jackels, Pharm. Med. imag, Section III, Chap. 20, p645 (1990), expressly incorporated herein by reference, which describes a large number of macrocyclic chelators and their synthesis. Similarly, there are a number of patents which describe suitable chelators for use in the invention, including U.S. Pat. Nos. 5,155,215, 5,087,440, 5,219,553, 5,188,816, 4,885,363, 5,358,704, 5,262,532, and Meyer et al., Invest. Radiol. 25: S53 (1990), all of which are also expressly incorporated by reference. Thus, as will be understood by those in the art, any of the known paramagnetic metal ion chelators or lanthanide chelators can be easily modified using the teachings herein to further comprise at least one blocking moiety.

Accordingly, the present invention provides a number of suitable chelators for use in the imaging moieties of the present invention. Some of the chelators shown herein do not depict the chelated metal ion, although those in the art would know that the chelators may be present.

When the metal ion is Gd(III), a preferred chelator is 1,4,7,10-tetraazacyclododecane-N,N′,N″, N′″-tetracetic acid (DOTA) or substituted DOTA. DOTA has the structure shown below:

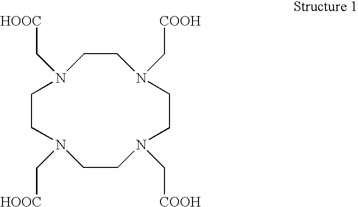

By “substituted DOTA” herein is meant that the DOTA may be substituted at any of the following positions, as shown below:

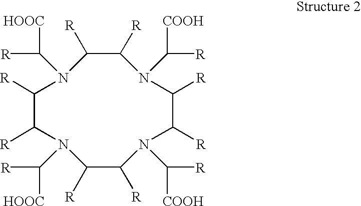

Suitable R substitution groups include a wide variety of groups, as will be understood by those in the art. For example, suitable substitution groups include substitution groups disclosed for DOTA and DOTA-type compounds in U.S. Pat. Nos. 5,262,532, 4,885,363, and 5,358,704. These groups include hydrogen, alkyl groups including substituted alkyl groups and heteroalkyl groups, aryl groups including substituted aryl and heteroaryl groups, phosphorus moieties, and blocking moieties.

As will be appreciated by those skilled in the art, each position designated above may have two R groups attached (R′ and R″), although in a preferred embodiment only a single non-hydrogen R group is attached at any particular position; that is, preferably at least one of the R groups at each position is hydrogen. Thus, if R is an alkyl or aryl group, there is generally an additional hydrogen attached to the carbon, although not depicted herein. In a preferred embodiment, one R group is a blocking moiety and the other R groups are hydrogen.

By “alkyl group” or grammatical equivalents herein is meant a straight or branched chain alkyl group, with straight chain alkyl groups being preferred. If branched, it may be branched at one or more positions, and unless specified, at any position. Also included within the definition of alkyl are heteroalkyl groups, wherein the heteroatom is selected from nitrogen, oxygen, phosphorus, sulfur and silicon. Also included within the definition of an alkyl group are cycloalkyl groups such as C5 and C6 rings, and heterocycloalkyl.

Additional suitable heterocyclic substituted rings are depicted in U.S. Pat. No. 5,087,440, expressly incorporated by reference. In some embodiments, two adjacent R groups may be bonded together to form ring structures together with the carbon atoms of the chelator, such as is described in U.S. Pat. No. 5,358,704, expressly incorporated by reference. These ring structures may be similarly substituted.

The alkyl group may range from about 1 to 20 carbon atoms (C1-C20), with a preferred embodiment utilizing from about 1 to about 10 carbon atoms (C1-C10), with about C1 through about C5 being preferred. However, in some embodiments, the alkyl group may be larger, for example when the alkyl group is the coordination site barrier.

By “alkyl amine” or grammatical equivalents herein is meant an alkyl group as defined above, substituted with an amine group at any position. In addition, the alkyl amine may have other substitution groups, as outlined above for alkyl group. The amine may be primary (—NH₂R), secondary (—NHR₂), or tertiary (—NR₃). When the amine is a secondary or tertiary amine, suitable R groups are alkyl groups as defined above. A preferred alkyl amine is p-aminobenzyl. When the alkyl amine serves as the coordination site barrier, as described below, preferred embodiments utilize the nitrogen atom of the amine as a coordination atom, for example when the alkyl amine includes a pyridine or pyrrole ring.

By “aryl group” or grammatical equivalents herein is meant aromatic aryl rings such as phenyl, heterocyclic aromatic rings such as pyridine, furan, thiophene, pyrrole, indole and purine, and heterocyclic rings with nitrogen, oxygen, sulfur or phosphorus.

Included within the definition of “alkyl” and “aryl” are substituted alkyl and aryl groups. That is, the alkyl and aryl groups may be substituted, with one or more substitution groups. For example, a phenyl group may be a substituted phenyl group. Suitable substitution groups include, but are not limited to, halogens such as chlorine, bromine and fluorine, amines, hydroxy groups, carboxylic acids, nitro groups, carbonyl and other alkyl and aryl groups as defined herein. Thus, arylalkyl and hydroxyalkyl groups are also suitable for use in the invention. Preferred substitution groups include alkyl amines and alkyl hydroxy.

By “ketone” herein is meant —R—CO—R—.

By “imino group” herein is meant —C—NH—C.

By “carbonyl” herein is meant —CO.

By “phosphorous moieties” herein is meant moieties containing the —PO(OH)(R₂₅)₂ group. The phosphorus may be an alkyl phosphorus; for example, DOTEP utilizes ethylphosphorus as a substitution group on DOTA. R₂₅ may be alkyl, substituted alkyl, hydroxy. A preferred embodiment has a —PO(OH)₂R₂₅ group.

By “amino groups” or grammatical equivalents herein is meant —NH₂, —NHR and —NR₂ groups, with R being as defined herein.

By “nitro group” herein is meant an —NO₂ group.

By “sulfur containing moieties” herein is meant compounds containing sulfur atoms, including but not limited to, thia-, thio- and sulfo-compounds, thiols (—SH and —SR), and sulfides (—RSR—).

By “silicon containing moieties” herein is meant compounds containing silicon.

By “aldehyde” herein is meant an —RCOH group.

By “ether” herein is meant an —R—O—R group.

By “alkyoxy group” herein is meant an —OR group.

By “ether” herein is meant an —O—R group. Preferred ethers include alkoxy groups, with —O—(CH₂)₂CH₃ and —O—(CH₂)₄CH₃ being preferred.

By “alkyoxy group” herein is meant an —OR group.

By “ester” herein is meant a —COOR group.

By “halogen” herein is meant bromine, iodine, chlorine, or fluorine. Preferred substituted alkyls are partially or fully halogenated alkyls such as CF₃, etc.

By “aldehyde” herein is meant —RCOH groups.

By “alcohol” herein is meant —OH groups, and alkyl alcohols —ROH.

By “amido” herein is meant —RCONH— or RCONR— groups.

By “ethylene glycol” or “(poly)ethylene glycol” herein is meant a —(O—CH₂—CH₂)ₙ— group, although each carbon atom of the ethylene group may also be singly or doubly substituted, i.e. —(O—CR₂—CR₂)ₙ—, with R as described above. Ethylene glycol derivatives with other heteroatoms in place of oxygen (i.e. —(N—CH₂—CH₂)ₙ— or —(S—CH₂—CH₂)ₙ—, or with substitution groups) are also preferred.

The substitution group may also be hydrogen, blocking moiety, targeting moiety, or therapeutic blocking moiety, as is described below.

In addition to alkyl and aryl groups as outlined herein, the X moiety may be a peptide-based molecule. By “peptide” or “polypeptide” herein is meant a compound of about 2 to about 15 amino acid residues covalently linked by peptide bonds. Preferred embodiments utilize polypeptides from about 2 to about 8 amino acids, with about 2 to about 4 being the most preferred. Preferably, the amino acids are naturally occurring amino acids, although amino acid analogs and peptidomimitic structures are also useful, particularly when the peptide serves as all or part of the X moiety, or in the design of inhibitors or ligands. Under certain circumstances, the peptide may be only a single amino acid residue.

In a preferred embodiment, the X moiety is a peptidyl moiety that comprises a peptide backbone and utilizes either naturally occurring or synthetic side chains to serve as “arms”, e.g. the linkers and coordination moieties of the chelate structures. This may be particularly preferred for synthesis, when amino acid analogs with either complete “arms” or chemical functional groups that facilitate the addition of other components such as linkers and coordination moieties are used. That is, synthetic amino acid analogs can be made and then linked together to form the chelate structures of the invention using standard solid phase synthesis. In some cases, naturally occurring amino acids that already comprise chemically useful groups for the attachment of additional linker atoms and/or coordination moieties can be used; for example, lysines and arginines already contain a primary amine that can be used for subsequent attachment of additional chemistry. In some embodiments, the side chains of the peptide can serve partially as the linker moieties.

In the structures outlined herein, Y can be a linker. As for the X moieties outlined herein, the skilled artisan will appreciated that a wide variety of Y moieties are possible as well. As for the X moieties, preferred Y linkers include alkyl and aryl linkers, particularly heteroalkyl and heteroaryl linkers.

In an alternative embodiment, when the metal ion is Gd(III), a preferred chelator is diethylenetriaminepentaacetic acid (DTPA) or substituted DTPA. DPTA has the structure shown below:

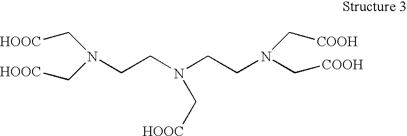

By “substituted DPTA” herein is meant that the DPTA may be substituted at any of the following positions, as shown below

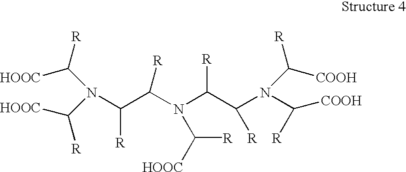

See for example U.S. Pat. No. 5,087,440.

Suitable R substitution groups include those outlined above for DOTA. Again, those skilled in the art will appreciate that there may be two R groups (R′ and R″) at each position designated above, although as described herein, at least one of the groups at each position is hydrogen, which is generally not depicted herein.

In an alternative embodiment, when the metal ion is Gd(III), a preferred chelator is 1,4,7,10-tetraazacyclododecane-N,N′,N″,N′″-tetraethylphosphorus (DOTEP) or substituted DOTEP (see U.S. Pat. No. 5,188,816). DOTEP has the structure shown below:

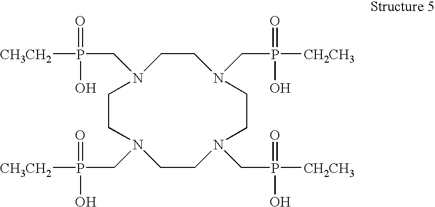

DOTEP may have similar R substitution groups as outlined above.

Other suitable Gd(III) chelators are described in Alexander, supra, Jackels, supra, U.S. Pat. Nos. 5,155,215, 5,087,440, 5,219,553, 5,188,816, 4,885,363, 5,358,704, 5,262,532, and Meyer et al., Invest. Radiol. 25: S53 (1990), among others.

When the paramagnetic ion is Fe(III), appropriate chelators will have less than 6 coordination atoms, since Fe(III) is capable of binding 6 coordination atoms. Suitable chelators for Fe(III) ions are well known in the art, see for example Lauffer et al., J. Am. Chem. Soc. 109:1622 (1987); Lauffer, Chem. Rev. 87:901-927 (1987); and U.S. Pat. Nos. 4,885,363, 5,358,704, and 5,262,532, all which describe chelators suitable for Fe(III).

When the paramagnetic ion is Mn(II) (Mn+2), appropriate chelators will have less than 5 or 6 coordination atoms, since Mn(II) is capable of binding 6 or 7 coordination atoms. Suitable chelators for Mn(II) ions are well known in the art; see for example Lauffer, Chem. Rev. 87:901-927 (1987) and U.S. Pat. Nos. 4,885,363, 5,358,704, and 5,262,532.

When the paramagnetic ion is Yt(III), appropriate chelators will have less than 7 or 8 coordination atoms, since Yt(III) is capable of binding 8 or 9 coordination atoms. Suitable chelators forYt(III) ions include, but are not limited to, DOTA and DPTA and derivatives thereof (see Moi et al., J. Am. Chem. Soc. 110:6266-6267 (1988)) and those chelators described in U.S. Pat. No. 4,885,363 and others, as outlined above.

When the paramagnetic ion is Dy+3 (Dy(III)), appropriate chelators will have less than 7 or 8 coordination atoms, since Dylll is capable of binding 8 or 9 coordination atoms. Suitable chelators are known in the art, as above.

In a preferred embodiment, the chelator and the blocking moiety are covalently linked; that is, the blocking moiety is a substitution group on the chelator. In this embodiment, the substituted chelator, with the bound metal ion, comprises the metal ion complex which in the absence of the target substance has all possible coordination sites occupied or blocked; i.e. it is coordinatively saturated.

In an alternative embodiment, the chelator and the blocking moiety are not covalently attached. In this embodiment, the blocking moiety has sufficient affinity for the metal ion to prevent the rapid exchange of water molecules in the absence of the target substance. However, in this embodiment the blocking moiety has a higher affinity for the target substance than for the metal ion. Accordingly, in the presence of the target substance, the blocking moiety will have a tendency to be dislodged from the metal ion to interact with the target substance, thus freeing up a coordination site in the metal ion complex and allowing the rapid exchange of water and an increase in relaxivity.

What is important is that the metal ion complex, comprising the metal ion, the chelator and the blocking moiety, is not readily able to rapidly exchange water molecules when the blocking moieties are in the inner coordination sphere of the metal ion, such that in the absence of the target substance, there is less or little substantial image enhancement.

In a preferred embodiment, the R group is a blocking moiety. In addition, at least one of the groups associated with the chelator (either an R group or a designated BM) is a blocking moiety.

By “blocking moiety” or grammatical equivalents herein is meant a functional group associated with the chelator metal ion complexes of the invention which is capable of interacting with a target substance and which is capable, under certain circumstances, of substantially blocking the exchange of water in at least one inner coordination site of the metal ion of the metal ion complex. For example, when bound to or associated with the metal ion complexes of the invention, the blocking moiety occupies or blocks at least one coordination site of the metal ion in the absence of the target substance. Thus, the metal ion is coordinately saturated with the chelator and the blocking moiety or moieties in the absence of the target substance.

A blocking moiety may comprise several components. The blocking moiety has a functional moiety which is capable of interacting with a target substance, as outlined below. This functional moiety may or may not provide the coordination atom(s) of the blocking moiety. In addition, blocking moieties may comprise one or more linker groups to allow for correct spacing and attachment of the components of the blocking moiety. Furthermore, in the embodiment where the functional group of the blocking moiety does not contribute a coordination atom, the blocking moiety may comprise a coordination site barrier, which serves to either provide a coordination site atom or sterically prevent the rapid exchange of water at the coordination site; i.e. the coordination site barrier may either occupy or block the coordination site.

By “capable of interacting with a target substance” herein is meant that the blocking moiety has an affinity for the target substance, such that the blocking moiety will stop blocking or occupying at least one coordination site of the metal ion complex when the target substance is present. Thus, as outlined above, the blocking moiety is blocking or occupying at least one coordination site of the metal ion in the absence of the target substance. However, in the presence of the target substance, the blocking moiety associates or interacts with the target substance and is released from its association with the metal ion, thus freeing at least one coordination site of the metal ion such that the rapid exchange of water can occur at this site, resulting in image enhancement.

The nature of the interaction between the blocking moiety and the target substance will depend on the target substance to be detected or visualized via MRI. For example, suitable target substances include, but are not limited to, enzymes; proteins; peptides; nucleic acids; ions such as Ca+2, Mg+2, Zn+2, K+, Cl−, and Na+; cAMP; receptors such as cell-surface receptors and ligands; hormones; antigens; antibodies; ATP; NADH; NADPH; FADH₂; FNNH₂; coenzyme A (acyl CoA and acetyl CoA); and biotin, among others.

In some embodiments, the nature of the interaction is irreversible, such that the blocking moiety does not reassociate to block or occupy the coordination site; for example, when the blocking moiety comprises an enzyme substrate which is cleaved upon exposure to the target enzyme. Alternatively, the nature of the interaction is reversible, such that the blocking moiety will reassociate with the complex to hinder the exchange of water; for example, when the blocking moiety comprises an ion ligand, or a receptor ligand, as outlined below.

The corresponding blocking moieties will be enzyme substrates or inhibitors, receptor ligands, antibodies, antigens, ion binding compounds, substantially complementary nucleic acids, nucleic acid binding proteins, etc.

In a preferred embodiment, the target substance is an enzyme, and the blocking moiety is an enzyme substrate. In this embodiment, the blocking moiety is cleaved from the metal ion complex of the invention, allowing the exchange of water in at least one coordination site of the metal ion complex. This embodiment allows the amplification of the image enhancement since a single molecule of the target substance is able to generate many activated metal ion complexes, i.e. metal ion complexes in which the blocking moiety is no longer occupying or blocking a coordination site of the metal ion.

As will be appreciated by those skilled in the art, the possible enzyme target substances are quite broad. The target substance enzyme may be chosen on the basis of a correlation to a disease condition, for example, for diagnostic purposes. Alternatively, the metal ion complexes of the present invention may be used to establish such correlations.

Suitable classes of enzymes include, but are not limited to, hydrolases such as proteases, carbohydrases, lipases and nucleases; isomerases such as racemases, epimerases, tautomerases, or mutases; transferases, kinases and phophatases.

As will be appreciated by those skilled in the art, the potential list of suitable enzyme targets is quite large. Enzymes associated with the generation or maintenance of arterioschlerotic plaques and lesions within the circulatory system, inflammation, wounds, immune response, tumors, may all be detected using the present invention. Enzymes such as lactase, maltase, sucrase or invertase, cellulase, α-amylase, aldolases, glycogen phosphorylase, kinases such as hexokinase, proteases such as serine, cysteine, aspartyl and metalloproteases may also be detected, including, but not limited to, trypsin, chymotrypsin, and other therapeutically relevant serine proteases such as tPA and the other proteases of the thrombolytic cascade; cysteine proteases including: the cathepsins, including cathepsin B, L, S, H, J, N and O; and calpain;; metalloproteinases including MMP-1 through MMP-10, particularly MMP-1, MMP-2, MMP-7 and MMP-9; and caspases, such as caspase-3, -5, -8 and other caspases of the apoptotic pathway, and, interleukin-converting enzyme (ICE). Similarly, bacterial and viral infections may be detected via characteristic bacterial and viral enzymes. As will be appreciated in the art, this list is not meant to be limiting.

Once the target enzyme is identified or chosen, enzyme substrate blocking moieties can be designed using well known parameters of enzyme substrate specificities.

For example, when the enzyme target substance is a protease, the blocking moiety may be a peptide or polypeptide which is capable of being cleaved by the target protease. By “peptide” or “polypeptide” herein is meant a compound of about 2 to about 15 amino acid residues covalently linked by peptide bonds. Preferred embodiments utilize polypeptides from about 2 to about 8 amino acids, with about 2 to about 4 being the most preferred. Preferably, the amino acids are naturally occurring amino acids, although amino acid analogs and peptidomimitic structures are also useful. Under certain circumstances, the peptide may be only a single amino acid residue.

Preferred target substance/peptide blocking moiety pairs include, but are not limited to, cat B and GGGF; cat B and GFQGVQFAGF; cat B and GFGSVGFAGF; cat B and GLVGGAGAGF; cat B and GGFLGLGAGF; cat D and GFGSTFFAGF; caspase-3 and DEVD; MMP-7 and PELR; MMP-7 and PLGLAR; MMP-7 and PGLWA-(D-arg); MMP-7 and PMALWMR; and MMP-7 and PMGLRA.

Similarly, when the enzyme target substance is a carbohydrase, the blocking moiety will be a carbohydrate group which is capable of being cleaved by the target carbohydrase. For example, when the enzyme target is lactase or β-galactosidase, the enzyme substrate blocking moiety is lactose or galactose. Similar enzyme/blocking moiety pairs include sucrase/sucrose, maltase/maltose, and α-amylase/amylose. In addition, the addition of carbohydrate moieties such as galactose, outlined herein, can alter the biodistribution of the agents; for example, the galactose blocking moieties outlined herein cause concentration in liver, kidneys and spleen.

In another embodiment, the blocking moiety may be an enzyme inhibitor, such that in the presence of the enzyme, the inhibitor blocking moiety disassociates from the metal ion complex to interact or bind to the enzyme, thus freeing an inner coordination sphere site of the metal ion for interaction with water. As above, the enzyme inhibitors are chosen on the basis of the enzyme target substance and the corresponding known characteristics of the enzyme.

In a preferred embodiment, the blocking moiety is a phosphorus moiety, as defined above, such as —OPO(OR₂))ₙ, wherein n is an integer from 1 to about 10, with from 1 to 5 being preferred and, to 3 being particularly preferred. Each R is independently hydrogen or a substitution group as defined herein, with hydrogen being preferred. This embodiment is particularly useful when the target molecule is alkaline phosphatase or a phosphodiesterase, or other enzymes known to cleave phosphorus containing moieties such as these.

In one embodiment, the blocking moiety is a nucleic acid. The nucleic acid may be single-stranded or double stranded, and includes nucleic acid analogs such as peptide nucleic acids and other well-known modifications of the ribose-phosphate backbone, such as phosphorthioates, phosphoramidates, morpholino structures, etc. The target molecule can be a substantially complementary nucleic acid or a nulceic acid binding moiety, such as a protein.

In a preferred embodiment, the target substance is a physiological agent. As for the enzyme/substrate embodiment, the physiological agent interacts with the blocking moiety of the metal ion complex, such that in the presence of the physiological agent, there is rapid exchange of water in at least one inner sphere coordination site of the metal ion complex. Thus, the target substance may be a physiologically active ion, and the blocking moiety is an ion binding ligand. For example, as shown in the Examples, the target substance may be the Ca+2 ion, and the blocking moiety may be a calcium binding ligand such as is known in the art (see Grynkiewicz et al., J. Biol. Chem. 260(6):3440-3450 (1985); Haugland, R. P., Molecular Probes Handbook of Fluorescent Probes and Research Chemicals (1989-1991)). Other suitable target ions include Mn+2, Mg+2, Zn+2, Na+, and Cl−.

When Ca+2 is the target substance, preferred blocking moieties include, but are not limited to, the acetic acid groups of bis(o-amino-phenoxy)ethane-N,N,N′,N′-tetraacetic acid (BAPTA), ethylene glycol bis(β-aminoethyl ether)-N,N,N′,N′-tetraacetic acid (EGTA); ethylenediaminetetracetic acid (EDTA); and derivatives thereof, such as disclosed in Tsien, Biochem. 19:2396-2404 (1980). Other known chelators of Ca+2 and other divalent ions, such as quin2 (2-[[2-[bis(carboxymethyl)amino]-5-methylphenoxy]methyl-6-methoxy-8-[bis(carboxymethyl)amino]quinoline; fura-1, fura-2, fura-3, stil-1, stil-2 and indo-1 (see Grynkiewicz et al., supra).

As for the enzyme/substrate embodiments, the metabolite may be associated with a particular disease or condition within an animal. For example, as outlined below, BAPTA-DOTA derivatives may be used to diagnose Alzeheimer's disease and other neurological disorders.

In a preferred embodiment, the blocking moiety is a ligand for a cell-surface receptor or is a ligand which has affinity for a extracellular component. In this embodiment, as for the physiological agent embodiment, the ligand has sufficient affinity for the metal ion to prevent the rapid exchange of water molecules in the absence of the target substance. Alternatively, there may be R groups “locking” the ligand into place, as described herein, resulting in either the contribution of a coordination atom or that the ligand serves as a coordination site barrier. In this embodiment the ligand blocking moiety has a higher affinity for the target substance than for the metal ion. Accordingly, in the presence of the target substance, the ligand blocking moiety will interact with the target substance, thus freeing up at least one coordination site in the metal ion complex and allowing the rapid exchange of water and an increase in relaxivity. Additionally, in this embodiment, this may result in the accumulation of the MRI contrast agent at the location of the target, for example at the cell surface. This may be similar to the situation where the blocking moiety is an enzyme inhibitor, as well.

In a preferred embodiment, the blocking moiety is a photocleavable moiety. That is, upon exposure to a certain wavelength of light, the blocking moiety is cleaved, allowing an increase in the exchange rate of water in at least one coordination site of the complex. This embodiment has particular use in developmental biology fields (cell lineage, neuronal development, etc.), where the ability to follow the fates of particular cells is desirable. Suitable photocleavable moieties are similar to “caged” reagents which are cleaved upon exposure to light. A particularly preferred class of photocleavable moieties are the O-nitrobenzylic compounds, which can be synthetically incorporated into a blocking moiety via an ether, thioether, ester (including phosphate esters), amine or similar linkage to a heteroatom (particularly oxygen, nitrogen or sulfur). Also of use are benzoin-based photocleavable moieties. A wide variety of suitable photocleavable moieties is outlined in the Molecular Probes Catalog, supra.

In a preferred embodiment, the compounds have a structure depicted below in Structure 18, which depicts a nitrobenzyl photocleavable group, although as will be appreciated by those in the art, a wide variety of other moieties may be used:

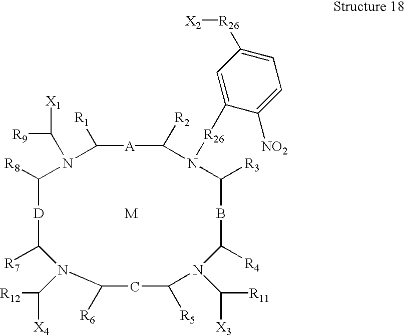

Structure 18 depicts a DOTA-type chelator, although as will be appreciated by those in the art, other chelators may be used as well. R₂₆ is a linker as defined below. Similarly, the X₂ group may be as defined above, although additional structures may be used, for example a coordination site barrier as outlined herein. Similarly, there may be substitutent groups on the aromatic ring, as is known in the art.

Included within the definition of “blocking moiety” is the therapeutic blocking moiety. By “therapeutic blocking moiety” or grammatical equivalents herein is meant a moiety with several essential functions. First, some component of the therapeutic blocking moiety must be capable of substantially inhibiting the exchange of water in at least one inner coordination site of the metal ion of the metal ion complex. Second, some component of the therapeutic blocking moiety must be capable of effecting a therapeutic effect, i.e. altering the function of its physiological target substance. In addition, a further requirement is that as a result of either the interaction of the therapeutic blocking moiety with the physiological target substance or as a result of the action of a separate enzyme such as a protease on a cleavage site present in the therapeutic blocking moiety, the exchange of water in at least one inner coordination site of the metal ion is increased. As is more fully described below, this is generally done as a result of a cleavage of some or all of the therapeutic blocking moiety off the chelator, although other types of interactions can be utilized as well. As is more fully described below, each of these functions may be accomplished by a single component, or multiple components are used, together forming the therapeutic blocking moiety. That is, for example, the therapeutically active agent may provide the coordination atom(s). Furthermore, as is more fully described below, the therapeutic blocking moiety may comprise a targeting moiety to allow targeting of the drug moiety to a particular target. Finally, therapeutic blocking moieties may comprise one or more linker groups to allow for correct spacing and attachment of the components of the therapeutic blocking moiety as needed.

Accordingly, a therapeutic blocking moiety can comprise one or more several components, as described herein. At a minimum, a therapeutic blocking moiety comprises a “therapeutically active agent” or “drug moiety” capable of causing a therapeutic effect, that is, it alters a biological function of a physiological target substance. As described below, this drug moiety may or may not provide the coordination atom(s) of the therapeutic blocking moiety. By “causing a therapeutic effect” or “therapeutically effective” or grammatical equivalents herein is meant that the drug alters the biological function of its intended physiological target in a manner sufficient to cause a therapeutic and phenotypic effect. By “alters” or “modulates the biological function” herein is meant that the physiological target undergoes a change in either the quality or quantity of its biological activity; this includes increases or decreases in activity. Thus, therapeutically active agents include a wide variety of drugs, including antagonists, for example enzyme inhibitors, and agonists, for example a transcription factor which results in an increase in the expression of a desirable gene product (although as will be appreciated by those in the art, antagonistic transcription factors may also be used), are all included.

In a preferred embodiment, the therapeutically active agent is cleaved from the MRI contrast agent, as is more fully described below. In this embodiment, as a result of cleavage of the therapeutic blocking moiety and the release of the therapeutically active agent, a coordination site of the MRI contrast agent is no longer occupied by a coordination atom and water is free to exchange in this site, leading to signal enhancement. Furthermore, the drug is now free to interact with its target, which may or may not be the same molecule which does the cleavage; for example, the cleavage site may comprise an enzyme substrate, for example of an HIV protease, and the drug may comprise an inhibitor of the same enzyme. Accordingly, in this embodiment, the nature of the interaction is irreversible; the coordination atom released from the MRI contrast agent does not reassociate to block or occupy the coordination site. This embodiment allows the amplification of the image enhancement since a single cleavage agent leads to the generation of many activated metal ion complexes, i.e. metal ion complexes in which the therapeutic blocking moiety is no longer occupying or blocking a coordination site of the metal ion.

In an alternate embodiment, the therapeutically active agent need not be cleaved from the MRI contrast agent to be active. Thus, for example, as is more fully described below, some agents can remain associated with the MRI contrast agent; what is important in this instance is that the association of the drug with its target causes a conformational alteration that results in a coordination site, originally occupied by a coordination atom from the therapeutic blocking moiety, to become vacated, allowing an increase in the exchange of water and thus image enhancement. That is, the affinity of the drug for its target is greater than the affinity of the therapeutic blocking moiety for the MRI contrast agent. Depending on the nature of the interaction of the drug with its physiological target, this may or may not be a reversible interaction. That is, in some cases, for example in the case of certain enzyme inhibitors, the interaction is effectively irreversible, leading to an enzyme active site being occupied with a drug attached to an MRI contrast agent. Alternatively, in some embodiments, the interaction is reversible, and an equilibrium is established between having the drug associated with its target (leading to image enhancement) and having the therapeutic blocking moiety associated with the MRI contrast agent (hindering the exchange of water and thus a loss of signal).

The nature of the therapeutic effect between the therapeutically active moiety and the physiological target substance will depend on the both the physiological target substance and the nature of the effect. In general, suitable physiological target substances include, but are not limited to, proteins (including peptides and oligopeptides) including ion channels and enzymes; nucleic acids; ions such as Ca+2, Mg+2, Zn+2, K+, Cl−, Na+, and toxic Eins including those of Fe, Pb, Hg and Se; cAMP; receptors including G-protein coupled receptors and cell-surface receptors and ligands; hormones; antigens; antibodies; ATP; NADH; NADPH; FADH₂; FNNH₂; coenzyme A (acyl CoA and acetyl CoA); and biotin, among others. Physiological target substances include enzymes and proteins associated with a wide variety of viruses including orthomyxoviruses, (e.g. influenza virus), paramyxoviruses (e.g respiratory syncytial virus, mumps virus, measles virus), adenoviruses, rhinoviruses, coronaviruses, reoviruses, togaviruses (e.g. rubella virus), parvoviruses, poxviruses (e.g. variola virus, vaccinia virus), enteroviruses (e.g. poliovirus, coxsackievirus), hepatitis viruses (including A, B and C), herpesviruses (e.g. Herpes simplex virus, varicella-zoster virus, cytomegalovirus, Epstein-Barr virus), rotaviruses, Norwalk viruses, hantavirus, arenavirus, rhabdovirus (e.g. rabies virus), retroviruses (including HIV, HTLV-I and -II), papovaviruses (e.g. papillomavirus), polyomaviruses, and picornaviruses, and the like. Similarly, bacterial targets can come from a wide variety of pathogenic and non-pathogenic prokaryotes of interest including Bacillus; Vibrio, e.g. V. cholerae; Escherichia, e.g. Enterotoxigenic E. coli, Shigella, e.g. S. dysenteriae; Salmonella, e.g. S. typhi; Mycobacterium e.g. M. tuberculosis, M. leprae; Clostridium, e.g. C. botulinum, C. tetani, C. difficile, C.perfringens; Cornyebacterium, e.g. C. diphtherae; Streptococcus, S. pyogenes, S. pneumoniae; Staphylococcus, e.g. S. aureus; Haemophilus, e.g. H. influenzae; Neisseria, e.g. N. meningitidis, N. gonorrhoeae; Yersinia, e.g. G. lamblia Y. pestis, Pseudomonas, e.g. P. aeruginosa, P. putida; Chlamydia, e.g. C. trachomatis; Bordetella, e.g. B. pertussis; Treponema, e.g. T. palladium; and the like.

Once the physiological target substance has been identified, a corresponding therapeutically active agent is chosen. These agents will be any of a wide variety of drugs, including, but not limited to, enzyme inhibitors, hormones, cytokines, growth factors, receptor ligands, antibodies, antigens, ion binding compounds including crown ethers and other chelators, substantially complementary nucleic acids, nucleic acid binding proteins including transcription factors, toxins, etc. Suitable drugs include cytokines such as erythropoietin (EPO), thrombopoietin (TPO), the interleukins (including IL-1 through IL-17), insulin, insulin-like growth factors (including IGF-1 and -2), epidermal growth factor (EGF), transforming growth factors (including TGF-α and TGF-β), human growth hormone, transferrin, epidermal growth factor (EGF), low density lipoprotein, high density lipoprotein, leptin, VEGF, PDGF, ciliary neurotrophic factor, prolactin, adrenocorticotropic hormone (ACTH), calcitonin, human chorionic gonadotropin, cotrisol, estradiol, follicle stimulating hormone (FSH), thyroid-stimulating hormone (TSH), leutinzing hormone (LH), progeterone, testosterone, toxins including ricin, and any drugs as described in the Physician's Desk Reference, Medical Economics Data Production Company, Montvale, N.J., 1998 and the Merck Index, 11th Edition (especially pages Ther-1 to Ther-29), both of which are expressly incorporated by reference.

In a preferred embodiment, the therapeutically active compound is a drug used to treat cancer. Suitable cancer drugs include, but are not limited to, antineoplastic drugs, including alkylating agents such as alkyl sulfonates (busulfan, improsulfan, piposulfan); aziridines (benzodepa, carboquone, meturedepa, uredepa); ethylenimines and methylmelamines (altretamine, triethylenemelamine, triethylenephosphoramide, triethylenethiophosphoramide, trimethylolmelamine); nitrogen mustards (chlorambucil, chlornaphazine, cyclophosphamide, estramustine, ifosfamide, mechlorethamine, mechlorethamine oxide hydrochloride, melphalan, novembichin, phenesterine, prednimustine, trofosfamide, uracil mustard); nitrosoureas (carmustine, chlorozotocin, fotenmustine, lomustine, nimustine, ranimustine); dacarbazine, mannomustine, mitobranitol, mitolactol; pipobroman; doxorubicin, and cisplatin (including derivatives).

In a preferred embodiment, the therapeutically active compound is an antiviral or antibacterial drug, including aclacinomycins, actinomycin, anthramycin, azaserine, bleomycins, cuctinomycin, carubicin, carzinophilin, chromomycins, ductinomycin, daunorubicin, 6-diazo-5-oxn-I-norieucine, duxorubicin, epirubicin, mitomycins, mycophenolic acid, nogalumycin, olivomycins, peplomycin, plicamycin, porfiromycin, puromycin, streptonigrin, streptozocin, tubercidin, ubenimex, zinostatin, zorubicin; aminoglycosides and polyene and macrolide antibiotics.

In a preferred embodiment, the therapeutically active compound is a radio-sensitizer drug. In a preferred embodiment, the therapeutically active compound is an anti-inflammatory drug (either steroidal or non-steroidal).

In a preferred embodiment, the therapeutically active compound is involved in angiogenesis. Suitable guarding moieties include, but are not limited to, endostatin, angiostatin, interferons, platelet factor 4 (PF4), thrombospondin, transforming growth factor beta, tissue inhibitors of metalloproteinase-1, -2 and -3 (TIMP-1, -2 and -3), TNP-470, Marimastat, Neovastat, BMS-275291, COL-3, AG3340, Thalidomide, Squalamine, Combrestastatin, SU5416, SU6668, IFN-α, EMD121974, CAI, IL-12 abnd IM862.

The blocking moiety itself may block or occupy at least one coordination site of the metal ion. That is, one or more atoms of the blocking moiety (i.e. the enzyme substrate, ligand, moiety which interacts with a physiological agent, photocleavable moiety, etc.) itself serves as a coordination atom, or otherwise blocks access to the metal ion by steric hinderance. For example, it appears that one or more of the atoms of the galactose blocking moiety outlined in the Examples may be direct coordination atoms for the Gd(III) metal ion. Similarly, peptide based blocking moieties for protease targets may contribute coordination atoms.

In an alternative embodiment, the blocking moiety further comprises a “coordination site barrier” which is covalently tethered to the complex in such a manner as to allow disassociation upon interaction with a target substance. For example, it may be tethered by one or more enzyme substrate blocking moieties. In this embodiment, the coordination site barrier blocks or occupies at least one of the coordination sites of the metal ion in the absence of the target enzyme substance. Coordination site barriers are used when coordination atoms are not provided by the functional portion of the blocking moiety, i.e. the component of the blocking moiety which interacts with the target substance. The blocking moiety or moieties such as an enzyme substrate serves as the tether, covalently linking the coordination site barrier to the metal ion complex. In the presence of the enzyme target, the enzyme cleaves one or more of the enzyme substrates, either within the substrate or at the point of attachment to the metal ion complex, thus freeing the coordination site barrier. The coordination site or sites are no longer blocked and the bulk water is free to rapidly exchange at the coordination site of the metal ion, thus enhancing the image. As will be appreciated by those in the art, a similar result can be accomplished with other types of blocking moieties.

In one embodiment, the coordination site barrier is attached to the metal ion complex at one end. When the enzyme target cleaves the substrate blocking moiety, the coordination site barrier is released. In another embodiment, the coordination site barrier is attached to the metal ion complex with more than one substrate blocking moiety for two attachments. The enzyme target may cleave only one side, thus removing the coordination site barrier and allowing the exchange of water at the coordination site, but leaving the coordination site barrier attached to the metal ion complex. Alternatively, the enzyme may cleave the coordination site barrier completely from the metal ion complex.

In a preferred embodiment, the coordination site barrier occupies at least one of the coordination sites of the metal ion. That is, the coordination site barrier contains at least one atom which serves as at least one coordination atom for the metal ion. In this embodiment, the coordination site barrier may be a heteroalkyl group, such as an alkyl amine group, as defined above, including alkyl pyridine, alkyl pyrroline, alkyl pyrrolidine, and alkyl pyrole, or a carboxylic or carbonyl group. The portion of the coordination site barrier which does not contribute the coordination atom may also be consider a linker group.

In an alternative embodiment, the coordination site barrier does not directly occupy a coordination site, but instead blocks the site sterically. In this embodiment, the coordination site barrier may be an alkyl or substituted group, as defined above, or other groups such as peptides, proteins, nucleic acids, etc.

In this embodiment, the coordination site barrier is preferably linked via two enzyme substrates to opposite sides of the metal ion complex, effectively “stretching” the coordination site barrier over the coordination site or sites of the metal ion complex.

In some embodiments, the coordination site barrier may be “stretched” via an enzyme substrate on one side, covalently attached to the metal ion complex, and a linker moeity, as defined below, on the other. In an alternative embodiment, the coordination site barrier is linked via a single enzyme substrate on one side; that is, the affinity of the coordination site barrier for the metal ion is higher than that of water, and thus the blocking moiety, comprising the coordination site barrier and the enzyme substrate, will block or occupy the available coordination sites in the absence of the target enzyme.

In some embodiments, the metal ion complexes of the invention have a single associated or bound blocking moiety. In such embodiments, the single blocking moiety impedes the exchange of water molecules in at least one coordination site. Alternatively, as is outlined below, a single blocking moiety may hinder the exchange of water molecules in more than one coordination site, or coordination sites on different chelators.

In alternative embodiments, two or more blocking moieties are associated with a single metal ion complex, to implede the exchange of water in at least one or more coordination sites.

It should be appreciated that the blocking moieties of the present invention may further comprise a linker group as well as a functional blocking moiety. That is, blocking moieties may comprise functional blocking moieties in combination with a linker group and/or a coordination site barrier.

Linker groups (sometimes depicted herein as R₂₆) will be used to optimize the steric considerations of the metal ion complex. That is, in order to optimize the interaction of the blocking moiety with the metal ion, linkers may be introduced to allow the functional blocking moiety to block or occupy the coordination site. In general, the linker group is chosen to allow a degree of structural flexibility. For example, when a blocking moiety interacts with a physiological agent which does not result in the blocking moiety being cleaved from the complex, the linker must allow some movement of the blocking moiety away from the complex, such that the exchange of water at at least one coordination site is increased.

Generally, suitable linker groups include, but are not limited to, alkyl and aryl groups, including substituted alkyl and aryl groups and heteroalkyl (particularly oxo groups) and heteroaryl groups, including alkyl amine groups, as defined above. Preferred linker groups include p-aminobenzyl, substituted p-aminobenzyl, diphenyl and substituted diphenyl, alkyl furan such as benzylfuran, carboxy, and straight chain alkyl groups of 1 to 10 carbons in length. Particularly preferred linkers include p-aminobenzyl, methyl, ethyl, propyl, butyl, pentyl, hexyl, acetic acid, propionic acid, aminobutyl, p-alkyl phenols, 4-alkylimidazole. The selection of the linker group is generally done using well known molecular modeling techniques, to optimize the obstruction of the coordination site or sites of the metal ion. The length of the linker, i.e., the spacer between the chelator and the coordination atom(s) of the blocking moiety, may contribute to the steric conformation and association of the coordination atoms with the metal ion, thus allowing blocking of the metal ion by the blocking moiety.

In a preferred embodiment, a coordination site barrier can be attached by a cleavable linker as outlined herein.

In a preferred embodiment esterase linkages are used. Esterase linkages are particularly preferred when the blocking moiety is attached via an “arm” of the chelate, as the product of an esterase reaction is a carboxylic acid, which thus allows the regeneration of a stable chelate (and, in the case of DOTA and DPTA, chelates that are approved for human use). Alternatively, cleavable peptide linkers can also be used.

The blocking moiety is attached to the metal ion complex in a variety of ways. In a preferred embodiment, as noted above, the blocking moiety is attached to the metal ion complex via a linker group. Alternatively, the blocking moiety is attached directly to the metal ion complex; for example, as outlined below, the blocking moiety may be a substituent group on the chelator.

In a preferred embodiment at least one of the R groups attached to the “arms” of the chelator, for example R₉, R₁₀, R₁₁ or R₁₂ of the DOTA structures, or R₁₃, R₁₄, R₁₇, R₂₀ or R₂₁ of the comprises an alkyl (including substituted and heteroalkyl groups), or aryl (including substituted and heteroaryl groups), i.e. is a group sterically bulkier than hydrogen. This is particular useful to drive the equilibrium towards “locking” the coordination atom of the arm into place to prevent water exchange, as is known for standard MRI contrast agents. Preferred groups include the C1 through C6 alkyl groups with methyl being particularly preferred.

This is particularly preferred when the blocking moiety is attached via one of the “arms”, for example when a blocking moiety is at position X₁ to X₄ (Structure 6), position S, T, U or V (Structure 8) or position H, I, J or K of Structure 16.

However the inclusion of too many groups may drive the equilibrium in the other direction effectively locking the coordination atom out of position, as is shown in Example 3. Therefore in a preferred embodiment only 1 or 2 of these positions is a non-hydrogen group, unless other methods are used to drive the equilibrium towards binding.

The blocking moieties are chosen and designed using a variety of parameters. In the embodiment which uses a coordination site barrier, i.e. when the functional group of the blocking moiety does not provide a coordination atom, and the coordination site barrier is fastened or secured on two sides, the affinity of the coordination site barrier of the blocking moiety for the metal ion complex need not be great, since it is tethered in place. That is, in this embodiment, the complex is “off” in the absence of the target substance. However, in the embodiment where the blocking moiety is linked to the complex in such a manner as to allow some rotation or flexibility of the blocking moiety, for example, it is linked on one side only, such as the galactose embodiment of the examples, the blocking moiety should be designed such that it occupies the coordination site a majority of the time.

When the blocking moiety is not covalently tethered on two sides, it should be understood that blocking moieties and coordination site barriers are chosen to maximize three basic interactions that allow the blocking moiety to be sufficiently associated with the complex to hinder the rapid exchange of water in at least one coordination site of the complex. First, there may be electrostatic interactions between the blocking moiety and the metal ion, to allow the blocking moiety to associate with the complex. Secondly, there may be Van der Waals and dipole-dipole interactions. Thirdly, there may be ligand interactions, that is, one or more functionalities of the blocking moiety may serve as coordination atoms for the metal. In addition, linker groups may be chosen to force or favor certain conformations, to drive the equilibrium towards an associated blocking moiety. Similarly, removing degrees of fredom in the molecule may force a particular conformation to prevail. Thus, for example, the addition of alkyl groups, and particularly methyl groups, at positions equivalent to the R₉ to R₁₂ positions of Structure 7 when the blocking moiety is attached at W, X, Y or Z, can lead the blocking moiety to favor the blocking position. Similar restrictions can be made in the other embodiments, as will be appreciated by those in the art.

Furthermore, effective “tethering” of the blocking moiety down over the metal ion may also be done by engineering in other non-covalent interactions that will serve to increase the affinity of the blocking moiety to the chelator complex, as is depicted below.

Potential blocking moieties may be easily tested to see if they are functional; that is, if they sufficiently occupy or block the appropriate coordination site or sites of the complex to prevent rapid exchange of water. Thus, for example, complexes are made with potential blocking moieties and then compared with the chelator without the blocking moiety in imaging experiments. Once it is shown that the blocking moiety is a sufficient “blocker”, the target substance is added and the experiments repeated, to show that interaction with the target substance increases the exchange of water and thus enhances the image.

Thus, as outlined above, the metal ion complexes of the present invention comprise a paramagnetic metal ion bound to a chelator and at least one blocking moiety. In a preferrred embodiment, the metal ion complexes have the formula shown in Structure 6:

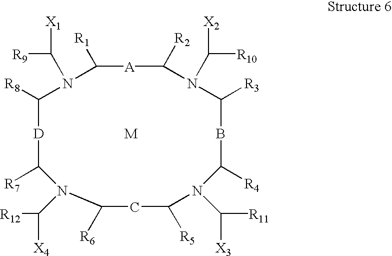

In Structure 6, M is a paramagnetic metal ion selected from the group consisting of Gd(III), Fe(III), Mn(II), Yt(III), and Dy(III). A, B. C and D are each either single or double bonds. The R₁ through R12 groups are alkyl or aryl groups, as defined above, including substituted alkyl and aryl groups, phosphorus groups, or a blocking moiety, as described above. X₁ through X₄ are —OH, —COO—, (CH2)ₙOH (with —CH₂OH being preferred), —(CH2)ₙCOO— (with CH₂COO— being preferred) or a blocking moiety. n is from 1 to 10, with from 1 to 5 being preferred. At least one of R₁ to R₁₂ and X₁ to X₄ is a blocking moiety.

Structure 6 includes Structures 7 and 8, shown below:

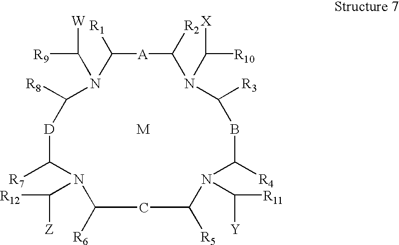

In this embodiment, W, X, Y and Z are as defined above for X, and at least one of the R₁ to R₁₂ groups is a blocking moiety.

As applied to DOTA, the four nitrogens of the DOTA ring, and the W, X, Y and Z groups provide 8 of the coordination atoms for the paramagnetic metal ion. The ninth coordination atom is provided by a blocking moiety which is substituted at one of the R₁ to R₁₂ positions. In a preferred embodiment, the other R groups are either hydrogen or methyl; in a particularly preferred embodiment the chelator is Gd-MCTA, which has a single methyl group on the DOTA ring (see Meyer et al., Invest. Radiol. 25:S53 (1990)).

In an alternative embodiment, the metal ion complexes have the formula depicted in Structure 8:

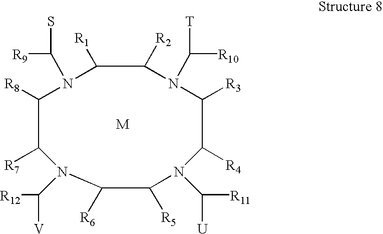

In this embodiment, S, T, U, and V are —OH, —COO—, —(CH2)ₙOH (with —CH₂OH being preferred), (CH2)ₙCOO— (with CH₂COO— being preferred) or a blocking moiety. In this embodiment, the four nitrogens of the DOTA ring, and three of the S, T, U or V groups provide 7 of the coordination atoms for the paramagnetic metal ion. The remaining coordination atoms are provided by a blocking moiety which is substituted at one of the S, T, U or V positions. Alternatively, the coordination sites are either filled by coordination atoms provided by the S, T, U or V groups, or blocked by the S, T, U or V structure, or both. In addition, Structure 8 does not depict the A, B, C and D bonds, but as for the other embodiments, these bonds may be either single or double bonds.

As applied to DOTA, the four nitrogens of the DOTA ring, and the (generally) three S, T and U groups provide 7 of the coordination atoms for the Gd(III) paramagnetic metal ion. The eigth and ninth coordination atoms are provided by a blocking moiety which is substituted at one of the S, T, U and V positions. As above, the other R groups are preferably either hydrogen or methyl, with Gd-MCTA being especially preferred.

In the Structures depicted herein, any or all of A, B, C or D may be a single bond or a double bond. It is to be understood that when one or more of these bonds are double bonds, there may be only a single substitutent group attached to the carbons of the double bond. For example, when A is a double bond, there may be only a single R₁ and a single R₂ group attached to the respective carbons; in a preferred embodiment, as described below, the R₁ and R₂ groups are hydrogen. In a preferred embodiment, A is a single bond, and it is possible to have two R₁ groups and two R₂ groups on the respective carbons. In a preferred embodiment, these groups are all hydrogen with the exception of a single blocking moiety, but alternate embodiments utilize two R groups which may be the same or different. That is, there may be a hydrogen and a blocking group attached in the R₁ position, and two hydrogens, two alkyl groups, or a hydrogen and an alkyl group in the R₂ positions.

It is to be understood that the exact composition of the X₁-X₄ (Structure 6) S, T, U, V (Structure 8) or W, X, Y and Z (Structure 7) groups will depend on the presence of the metal ion. That is, in the absence of the metal ion, the groups may be —OH, —COOH, —(CH₂)ₙOH, or (CH₂)ₙCOOH; however, when the metal is present, the groups may be —OH, —COO—, —(CH₂)ₙO—, or (CH₂)ₙCOO—.

In a preferred embodiment, the compositions have the formula shown in Structure 9:

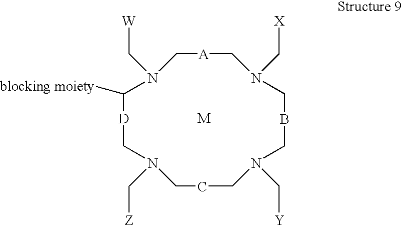

In this embodiment, there is a single blocking moiety attached to the metal ion complex. That is, all but one of the R groups are hydrogen. It should be appreciated that the blocking moiety may be at any of the R positions.

In a preferred embodiment the magnetic resonance imaging agents are used to detect Ca+2 ions, and have the structure depicted in Structure 10:

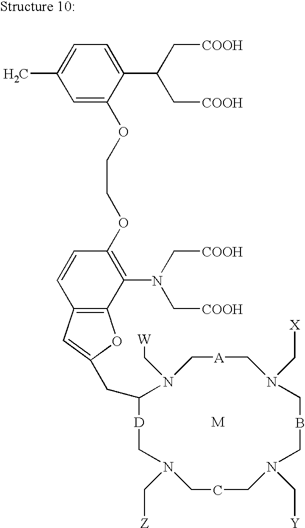

In this embodiment, the blocking moiety comprises a linker and the BAPTA molecule, although any of the fura-type Ca⁺² ligands may be substituted. Without being bound by theory, it appears that one of the carboxy groups of the BAPTA moiety serves to provide a coordination atom in the absence of Ca+2. However, in the presence of Ca+2, the carboxy group chelates Ca+2, and thus is unavailable as a coordination group, thus allowing the rapid exchange of water. Preferably, the metal ion is Gd(III), the R groups are all hydrogen, and the W, X, Y and Z groups are carboxy.

In one embodiment the carboxylic acid groups of the BAPTA molecule may be protected with acetate protecting groups, resulting a neutral molecule that may then cross membranes. Once inside a cell, intracellular esterases can cleave off the acetate protecting groups, allowing the detection of Ca⁺². See Li et al., Tetrahedron 53(35):12017-12040 (1997).

In a preferred embodiment, the compositions have the formula shown in Structure 11:

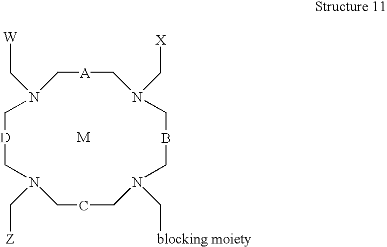

In this embodiment, there is a single blocking moiety attached to the metal ion complex. It should be appreciated that the blocking moiety may be at any of the S, T, U or V positions. Similarly, a single blocking moiety may be attached to DTPA.

In a preferred embodiment, the magnetic resonance imaging contrast agents have the structure shown in Structure 12:

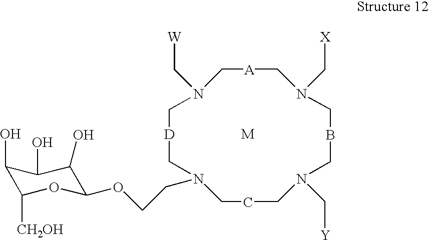

In this embodiment, the blocking moiety comprises a linker and a carbohydrate, attached to the complex via a β(1, 4) linkage such as is recognized by lactose or β-galactosidase. Without being bound by theory, it is apparent that the galactose moiety provides a coordination atom, such that in the absence of β-galactosidase there is reduced exchange of water in the complex. Upon exposure to β-galactosidase, the carbohydrate blocking moiety is cleaved off, removing the coordination atom and allowing the rapid exchange of water. Preferably, the R groups are hydrogen, and the W, X, Y and Z groups are carboxy.

In another embodiment, the metal ion complexes have the formula depicted in Structure 13:

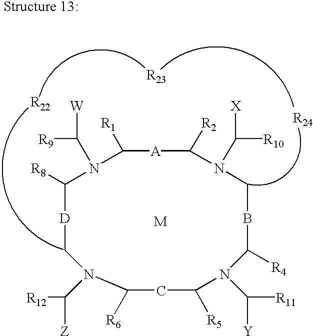

In this embodiment, R₂₂, R₂₃ and R₂₄ comprise a blocking moiety, with R₂₃ being a coordination site barrier which also serves to contribute a coordination atom. It is to be understood that the R₂₂ and R₂₄ groups may be attached at any of the R₁ to R₁₂ positions. Preferred R₂₃ groups include, but are not limited to, compounds listed above that provide a coordination atom, blocking moieties. R₂₂ and R₂₄ may also comprise a linker, as defined above and as shown in Structure 14, below. Preferred R, and R₂₄ groups include enzyme substrates which are cleaved upon exposure to the enzyme, such as carbohydrates and peptides. Accordingly, when the target substance is a carbohydrase such as β-galactosidase, the compositions have the formula shown in Structure 14:

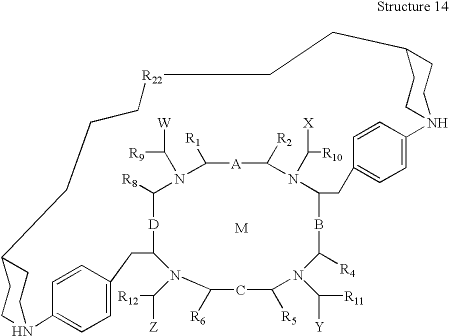

In this embodiment, the blocking moiety comprises two linkers, two carbohydrates, and a coordination site barrier. The carbohydrates are attached to the complex via a linkage which will be recognized by a carbohydrase such as a β(1, 4) linkage such as is recognized by lactose or β-galactosidase. The R₂₂ group provides a coordination atom in the absence of the carbohydrase such there is no rapid exchange of water in the complex. Upon exposure to the carbohydrase, such as β-galactosidase, one or both of the carbohydrate blocking moieties are cleaved off, removing the coordination atom and allowing the rapid exchange of water. Preferably, the R groups are hydrogen, and the W, X, Y and Z groups are carboxy. Alternatively, the blocking moiety could comprise peptides for a protease target substance.

In place of the carbohydrates in Structure 14, an alternative embodiment utilizes peptides. That is, a peptide comprising 2 to 5 amino acids or analogs may be “stretched” from one side of the complex to the other, and linker groups may or may not be used. Similarly, nucleic acids may be used.

Alternatively, there may not be covalent attachment at both ends. As discussed above, effective “tethering” of the blocking moiety down over the metal ion may also be done by engineering in other non-covalent interactions that will serve to increase the affinity of the blocking moiety to the chelator complex.Thus, for example, electrostatic interactions may be used, as is generally depicted below for a DOTA derivative in Structure 15:

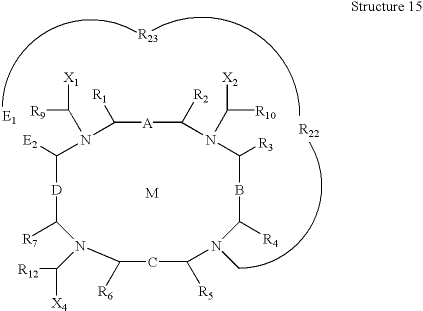

In Structure 15, the blocking moeity/coordination site barrier occupies the X₃ position, although any position may be utilized. E₁ and E₂ and electrostatic moieties bearing opposite charges. In Structure 15, the E₂ group is shown a position R₈, although any position may be used.

A further embodiment utilizes metal ion complexes having the formula shown in Structure 16:

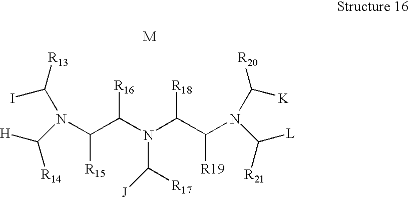

It is to be understood that, as above, the exact composition of the H, I, J, K and L groups will depend on the presence of the metal ion. That is, in the absence of the metal ion, H, I, J, K and L are —OH, —COOH, —(CH₂)ₙOH, or (CH₂)ₙCOOH; however, when the metal is present, the groups are —OH, —COO—, —(CH₂)ₙOH, or (CH₂)ₙCOO—.

In this embodiment, R₁₃ through R₂₁ are alkyl or aryl, including substituted and hetero derivatives, a phosphorus moiety or a blocking moiety, all as defined above. in a preferred embodiment, R₁₂ to R₂₁ are hydrogen. At least one of R₁₃-R₂₁, H, I, J, K or L is a blocking moiety, as defined above.

In a preferred embodiment, the MRI contrast agents of the invention comprise more than one metal ion, such that the signal is increased. As is outlined below, this may be done in a number of ways, including, but not limited to, the use of multiple metal ions in a single chelate, the use of a single blocking moiety to block more than one chelated metal ion, or the oligomerization of the agents of the invention, including both multimers and the use of polymeric linkers to attach agents together.

In a preferred embodiment, the MRI contrast agents of the invention comprise at least two paramagnetic metal ions, each with a chelator and blocking moiety; that is, multimeric MRI contrast agents are made. In a preferred embodiment, the chelators are linked together, either directly or through the use of a linker such as a coupling moiety or polymer. For example, using substitution groups that serve as functional groups for chemical attachment on the chelator, attachment to other chelators may be accomplished. As will be appreciated by those in the art, attachment of more than one MRI contrast agent may also be done via the blocking moieties (or coordination site barriers, etc.), although these are generally not preferred.

In a preferred embodiment, the chelators of the invention include one or more substitution groups that serve as functional groups for chemical attachment. Suitable functional groups include, but are not limited to, amines (preferably primary amines), carboxy groups, and thiols (including SPDP, alkyl and aryl halides, maleimides, α-haloacetyls, and pyridyl disulfides) are useful as functional groups that can allow attachment.

Examples of chelates useful in the imaging moieties of the present invention are described below and in U.S. patent application entitled “Novel Macrocyclic Activatable Magnetic Resonance Imagine Contrast Agents” of Thomas J. Meade, filed Apr. 22, 2002, expressly incorporated herein by reference. In the following examples, “BM” refers to blocking moiety.

In a preferred embodiment, the chelate has the formula:

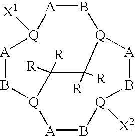

wherein

each Q is independently selected from the group consisting of nitrogen, oxygen or sulfur; A—B is a structure selected from the group consisting of —CR₂—CR₂—, —CR═CR—, —CR₂—CR₂—CR₂—, —CR═CR—CR₂— and —CR₂—CR═CR—;

X1 and X2 are independently selected from the group consisting of CR₂COO^{-, CR}₂COOH, CR₂(BM), CR(CR₂COO⁻)₂, CR(CR₂COO⁻)(BM), CR2CO_{O}COOH)₂ and CR(CR₂COOH)(BM), wherein BM is a blocking moiety; and

each R is independently selected from the group consisting of hydrogen, alkyl, aryl, alcohol, amine, amido, nitro, ether, ester, ketone, imino, aldehyde, alkoxy, carbonyl, halogen, sulfur containing moiety, phosphorus containing moiety, targeting moiety, blocking moiety, or, together with an adjacent R group forms an alkyl or aryl group;

wherein either:

a) X¹ or X² comprises a BM; or

b) at least one R comprises a BM.

In another preferred embodiment, the chelates have the formula:

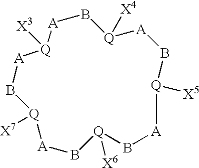

wherein

each Q is independently selected from the group consisting of nitrogen, oxygen or sulfur;

A—B is a structure selected from the group consisting of —CR₂—CR₂—, —CR═CR—, —CR₂—CR₂—CR₂—, —CR═CR—CR₂— and —CR₂—CR═CR—;

X³, X⁴, X⁵, X⁶ and X⁷ are independently selected from the group consisting of —(CR₂)nCOO⁻, —(CR₂₎ₙCOOH, (CR₂)n(BM), —CR(CR₂COO⁻)₂, —CR(CR₂COO⁻)(BM), —CR(CR₂COOH)₂ and —CR(CR₂COOH)(BM), —(CR₂)n-CR((CR₂)m-COOH)2, —(CR₂)n-CR((CR₂)m-COO⁻)2, —(CR₂)m-CR[((CR₂)m-COOH))((CR₂)m-BM), —(CR₂)n-C(CR₂)m-COOH)3; and —C((CR₂)n-COOH)3, wherein BM is a blocking moiety;

each R is independently selected from the group consisting of hydrogen, alkyl, aryl, alcohol, amine, amido, nitro, ether, ester, ketone, imino, aldehyde, alkoxy, carbonyl, halogen, sulfur containing moiety, phosphorus containing moiety, blocking moiety, or, together with an adjacent R group forms an alkyl or aryl group;

wherein optionally two of X³-X⁷ are joined to form —CR₂—CR₂—, —CR═CR—, —CR₂—CR₂—CR₂— or —CR═CR—CR₂—; and

wherein either:

a) X³, X⁴, X⁵, X⁶ or X⁷ comprises a BM; or

b) at least one R comprises a BM.

In another preferred embodiment, the chelates have the formula:

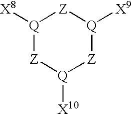

wherein

each Q is independently selected from the group consisting of nitrogen, sulfur or oxygen;

each Z is —(CR₂)n- wherein n is at least 1 and R is a substitution group;

at least two of X⁸-X¹⁰ are selected from the group consisting of hydrogen, R, blocking moiety, —(CR₂)nCOO⁻, —(CR₂₎ₙCOOH, (CR₂)n(BM), —CR(CR₂COO⁻)₂, —CR(CR₂COO⁻)(BM), —CR(CR₂COOH)₂ and —CR(CR₂COOH)(BM), —(CR₂)n-CR((CR₂)m-COOH)2, —(CR₂)n-CR((CR₂)m-COO⁻)2, —(CR₂)m-CR[((CR₂)m-COOH))((CR₂)m-BM), —(CR₂)n-C(CR₂)m-COOH)3; and —C((CR₂)n-COOH)3;

wherein at least one R or X comprises a BM.

In a preferred embodiment, the chelates have the formula:

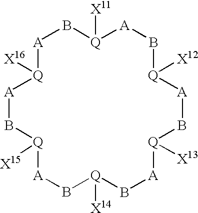

wherein

A and B are selected from the group consisting of CR₂—CR₂, CR═CR, CR₂—CR₂—CR₂, CR═CR—CR₂, and CR₂—CR═CR;

each Q is independently selected from the group consisting of nitrogen, sulfur or oxygen;

each R is independently selected from the group consisting of hydrogen, alkyl, aryl, alcohol, amine, amido, nitro, ether, ester, ketone, imino, aldehyde, alkoxy, carbonyl, halogen, sulfur containing moiety, phosphorus containing moiety, blocking moiety, or, together with an adjacent R group forms an alkyl or aryl group, or together with an non adjacent R group forms an alkyl or aryl group;

wherein X¹¹-X¹⁶ are selected from the group consisting of hydrogen, R, blocking moiety, —(CR₂)nCOO⁻, —(CR₂₎ₙCOOH, (CR₂)n(BM), —CR(CR₂COO⁻)₂, —CR(CR₂COO⁻)(BM), —CR(CR₂COOH)₂ and —CR(CR₂COOH)(BM), —(CR₂)n-CR((CR₂)m-COOH )2, —(CR₂)n-CR((CR₂)m-COO⁻)2, —(CR₂)m-CR[((CR₂)m-COOH))((CR₂)m-BM), —(CR₂)n-C(CR₂)m-COOH)3; and —C((CR₂)n-COOH)3;

wherein optionally two of X¹-X⁷ are joined to form a C1-5 alkyl group;

wherein either:

a) X¹¹, X¹², X¹³, X¹⁴, X¹⁵ or X¹⁶ comprises a BM; or

b) at least one R comprises a BM.

In a preferred embodiment, the chelates have the formula:

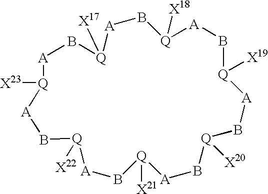

wherein

A and B are selected from the group consisting of CR₂—CR₂, CR═CR, CR₂—CR₂—CR₂, CR═CR—CR₂, and CR₂—CR═CR;

each Q is independently selected from the group consisting of nitrogen, sulfur or oxygen;

each R is independently selected from the group consisting of hydrogen, alkyl, aryl, alcohol, amine, amido, nitro, ether, ester, ketone, imino, aldehyde, alkoxy, carbonyl, halogen, sulfur containing moiety, phosphorus containing moiety, blocking moiety, or, together with an adjacent R group forms an alkyl or aryl group, or together with an non adjacent R group forms an alkyl or aryl group;

wherein each of X²³ are independently selected from the group consisting of hydrogen, R, blocking moiety, —(CR₂)nCOO⁻, —(CR₂₎ₙCOOH, (CR₂)n(BM), —CR(CR₂COO⁻)₂, —CR(CR₂COO⁻)(BM), —CR(CR₂COOH)₂ and —CR(CR₂COOH)(BM), —(CR₂)n-CR((CR₂)m-COOH)2, —(CR₂)n-CR((CR₂)m-COO⁻)2, —(CR₂)m-CR[((CR₂)m-COOH))((CR₂)m-BM), —(CR₂)n-C(CR₂)m-COOH)3; and —C((CR₂)n-COOH)3;

wherein optionally two of X¹⁷-X²³ are joined to form a C1-10 alkyl group;

wherein either:

a)X¹⁷, X¹⁸, X¹⁹, X²⁰, X²¹, X²²or X²³comprises a BM; or

b) at least one R comprises a BM.

In one embodiment, the chelators are linked together directly, using at least one functional group on each chelator. This may be accomplished using any number of stable bifunctional groups well known in the art, including homobifunctional and heterobifunctional linkers (see Pierce Catalog and Handbook, 1994, pages T155-T200, hereby expressly incorporated by reference). This may result in direct linkage, for example when one chelator comprises a primary amine as a functional group and the second comprises a carboxy group as the functional group, and carbodiimide is used as an agent to activate the carboxy for attach by the nucleophilic amine (see Torchilin et al., Critical Rev. Therapeutic Drug Carrier Systems, 7(4):275-308 (1991). Alternatively, as will be appreciated by those in the art, the use of some bifunctional linkers results in a short coupling moiety being present in the structure. A “coupling moiety” is capable of covalently linking two or more entities. In this embodiment, one end or part of the coupling moiety is attached to the first MRI contrast agent, and the other is attached to the second MRI contrast agent. The functional group(s) of the coupling moiety are generally attached to additional atoms, such as alkyl or aryl groups (including hetero alkyl and aryl, and substituted derivatives), to form the coupling moiety. Oxo linkers are also preferred. As will be appreciated by those in the art, a wide range of coupling moieties are possible, and are generally only limited by the ability to synthesize the molecule and the reactivity of the functional group. Generally, the coupling moiety comprises at least one carbon atom, due to synthetic requirements; however, in some embodiments, the coupling moiety may comprise just the functional group.

In a preferred embodiment, the coupling moiety comprises additional atoms as a spacer. As will be appreciated by those in the art, a wide variety of groups may be used. For example, a coupling moiety may comprise an alkyl or aryl group substituted with one or more functional groups. Thus, in one embodiment, a coupling moiety containing a multiplicity of functional groups for attachment of multiple MRI contrast agents may be used, similar to the polymer embodiment described below. For example, branched alkyl groups containing multiple functional groups may be desirable in some embodiments.

The imaging moieties of the present invention comprise a polymer and a plurality of MRI contrast agents each linked to the polymer by a cleavable linkage. As will be appreciated by those in the art, these MRI contrast agents may be monomeric (i.e. one metal ion, one chelator, one blocking moiety) or a duplex, as is generally described below (i.e. two metal ions, two chelators, one blocking moiety).

Preferred embodiments utilize a plurality of MRI contrast agents per polymer. The number of MRI contrast agents per polymer will depend on the density of MRI contrast agents per unit length and the length of the polymer.

The character of the polymer will vary, but what is important is that the polymer either contain or can be modified to contain functional groups for the the attachment of the MRI contrast agents and, optionally, one or more target moieties. Suitable polymers include, but are not limited to, functionalized dextrans, styrene polymers, polyethylene and derivatives, polyanions including, but not limited to, polymers of heparin, polygalacturonic acid, mucin, nucleic acids and their analogs including those with modified ribose-phosphate backbones, the polypeptides polyglutamate and polyaspartate, as well as carboxylic acid, phosphoric acid, and sulfonic acid derivatives of synthetic polymers; and polycations, including but not limited to, synthetic polycations based on acrylamide and 2-acrylamido-2-methylpropanetrimethylamine, poly(N-ethyl-4-vinylpyridine) or similar quarternized polypyridine, diethylaminoethyl polymers and dextran conjugates, polymyxin B sulfate, lipopolyamines, poly(allylamines) such as the strong polycation poly(dimethyldiallylammonium chloride), polyethyleneimine, polybrene, spermine, spermidine and polypeptides such as protamine, the histone polypeptides, polylysine, polyarginine and polyornithine; and mixtures and derivatives of these. Particularly preferred polycations are polylysine and spermidine, with the former being especially preferred. Both optical isomers of polylysine can be used. The D isomer has the advantage of having long-term resistance to cellular proteases. The L isomer has the advantage of being more rapidly cleared from the subject. As will be appreciated by those in the art, linear and branched polymers may be used.

A preferred polymer is polylysine, as the —NH₂ groups of the lysine side chains at high pH serve as strong nucleophiles for multiple attachment of activated chelating agents. At high pH the lysine monomers are coupled to the MRI contrast agents under conditions that yield on average 5-20% monomer substitution.

In some embodiments, particularly when charged polymers are used, there may be a second polymer of opposite charge to the first that is electrostatically associated with the first polymer, to reduce the overall charge of polymer-MRI contrast agent complex. This second polymer may or may not contain MRI contrast agents.

The size of the polymer may vary substantially. For example, it is known that some nucleic acid vectors can deliver genes up to 100 kilobases in length, and artificial chromosomes (megabases) have been delivered to yeast. Therefore, there is no general size limit to the polymer. However, a preferred size for the polymer is from about 10 to about 50,000 monomer units, with from about 2000 to about 5000 being particularly preferred, and from about 3 to about 25 being especially preferred.

It should be understood that the multimeric MRI contrast agents of the invention may be made in a variety of ways, including those described herein. What is important is that the manner of attachment does not significantly alter the functionality of the agents; that is, the agents must still be “off” in the absence of the target substance and “on” in its presence.

Similarly, it should be understood that the target moieties of the invention may be made in a variety of ways, including those described herein. What is important is that the manner of attachment does not significantly alter the functionality of the target moiety.

In a preferred embodiment, the MRI contrast agents of the invention are “duplexes”. In this embodiment, the MRI duplex comprises two chelators, each with a paramagnetic metal ion, and at least one blocking moiety that restricts the exchange of water in at least one coordination site of each chelator. In this way, a sort of signal amplification occurs, with two metal ions increasing the signal with a single target molecule. While “duplex” implies two chelators, it is intended to refer to complexes comprising a single blocking moiety donating coordination atoms to more than 1 metal ion/chelator complex. As will be appreciated by those in the art, the MRI contrast agents of this embodiment may have a number of different conformations. As will be appreciated by those in the art, the R₂₆, R₂₇ and R₂₈ groups can be attached to any of the positions described herein, to any R groups or X₁-X₄, S, T, U, V, W, X, Y, or Z groups.

As outlined above, the MRI duplex moieties may also be combined into higher multimers, either by direct linkage or via attachment to a polymer.

In a preferred embodiment, the chelator and the blocking moiety are covalently linked; that is, the blocking moiety is a substitution group on the chelator. In this embodiment, the substituted chelator, with the bound metal ion, comprises the metal ion complex which in the absence of the target substance has all possible coordination sites occupied or blocked; i.e. it is coordinatively saturated.

In an alternative embodiment, the chelator and the blocking moiety are not covalently attached. In this embodiment, the blocking moiety has sufficient affinity for the metal ion to prevent the rapid exchange of water molecules in the absence of the target substance. However, in this embodiment the blocking moiety has a higher affinity for the target substance than for the metal ion. Accordingly, in the presence of the target substance, the blocking moiety will have a tendency to be dislodged from the metal ion to interact with the target substance, thus freeing up a coordination site in the metal ion complex and allowing the rapid exchange of water and an increase in relaxivity.

What is important is that the metal ion complex, comprising the metal ion, the chelator and the blocking moiety, is not readily able to rapidly exchange water molecules when the blocking moeities are in the inner coordination sphere of the metal ion, such that in the absence of the target substance, there is less or little substantial image enhancement.

The complexes of the invention are generally synthesized using well known techniques. See, for example, Moi et al., supra; Tsien et al., supra; Borch et al., J. Am. Chem. Soc., p2987 (1971);

Alexander, (1995), supra; Jackels (1990), supra, U.S. Pat. Nos. 5,155,215, 5,087,440, 5,219,553, 5,188,816, 4,885,363, 5,358,704, 5,262,532; Meyer et al., (1990), supra, Moi et al., (1988), and McMurray et al., Bioconjugate Chem. 3(2):108-117 (1992)).

The contrast agents of the invention are complexed with the appropriate metal ion as is known in the art. while the structures depicted herein all comprise metal ion, it is to be understood that the contrast agents of the invention need not have a metal ion present initially. Metal ions can be added to water in the form of an oxide or in the form of a halide and treated with an equimolar amount of a contrast agent composition. The contrast agent may be added as an aqueous solution or suspension. Dilute acid or base can be added if there is a need to maintain a neutral pH. Heating at temperatures as high as 100° C. may be required.

In a preferred embodiment, the blocking moiety is BAPTA, as is generally depicted below in Structure 17, with propyl linking groups between the chelators and the BAPTA derivative:

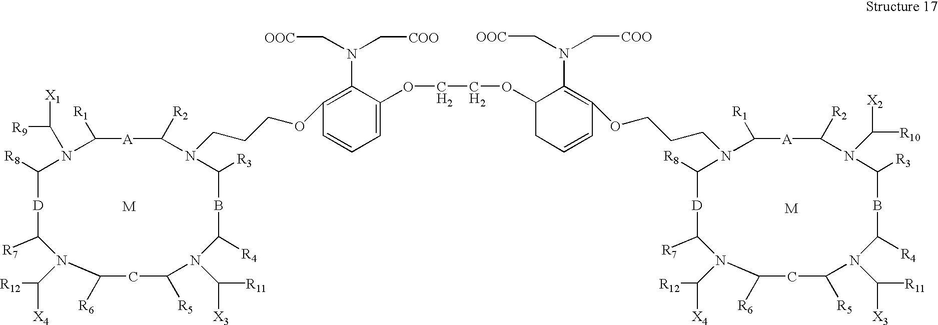

As will be appreciated by those in the art, the structure depicted in Structure 17 may be altered, for example, replacing the phenyl groups of the BAPTA derivative with cycloalkyl groups, or removing them entirely, as is generally depicted in Structure 19:

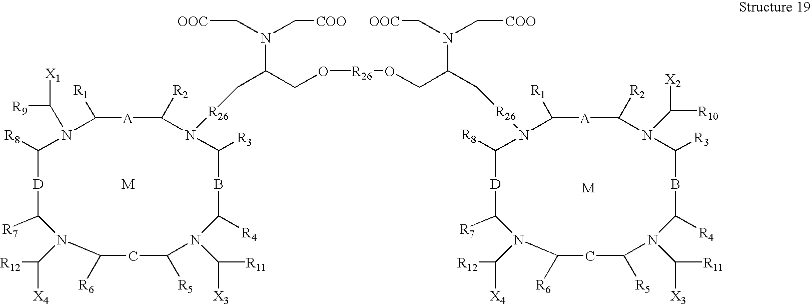

As noted above, the carboxylic acids of the BAPTA molecule may also be protected using acetate protecting groups, to render a neutral molecule for entry into cells, that then can be reactivated via cleavage by intracellular esterases.

In addition, although Structures 17 and 19 have ethylene groups between the oxygens of the bridge of BAPTA, methylene and propylene may also be used, as well as substituted derivatives of these.

In a preferred embodiment, A, B, C and D are single bonds, R₁-R₁₂ are hydrogen, and each R₂₆ is —CH₂O—, with the CH₂ group being attached to the macrocycle.

The imaging moieties of the present invention can further comprise one or more targeting moieties. In a preferred embodiment, one or more targeting moieties are attached to the MRI contrast agent and/or the polymer. By the term “targeting moiety” herein is meant a functional group that serves to target or direct the complex to a particular location (e.g., cell type, or diseased tissue), or association (e.g., a specific binding event). In general, the targeting moiety is directed against a target molecule.

As will be appreciated by those in the art, the imaging moieties of the invention are generally injected intravenously. Thus, preferred targeting moieties are those that allow concentration of the imaging moieties or MRI contrast agents in a particular localization. Thus, for example, a targeting moiety may be used to target a molecule to a specific target protein or enzyme, or to a particular cellular location, or to a particular cell type. Suitable targeting moieties include, but are not limited to, peptides, amino acids, nucleic acids, carbohydrates, lipids, hormones including proteinaceous and steroid hormones, growth factors, receptor ligands, antigens, antibodies, sugars, dextrans, alcohols, bile acids, fatty acids, and the like. The targeting moieties may be attached o the ipolymer or MRI contrast agent in order to localize or target it to a particular site. For example, as is more fully outlined below, a therapeutically active agent such as the cobalt compounds outlined below may include a targeting moiety to specifically bind a particular protein. Alternatively, as is more fully outlined below, the imaging moieties of the invention may include a targeting moiety to target the agents to a specific cell type such as tumor cells, such as a transferrin moiety, since many tumor cells have significant transferrin receptors on their surfaces. Similarly, a targeting moiety may include components useful in targeting the imaging moieties or MRI contrast agents or the therapeutically active agents to a particular subcellular location. As will be appreciated by those in the art, the localization of proteins within a cell is a simple method for increasing effective concentration. For example, shuttling a drug into the nucleus confines them to a smaller space thereby increasing concentration. Finally, the physiological target may simply be localized to a specific compartment, and the drugs must be localized appropriately.

Thus, suitable targeting sequences include, but are not limited to, binding sequences capable of causing binding of the moiety to a predetermined molecule or class of molecules while retaining bioactivity of the expression product, (for example by using enzyme inhibitor or substrate sequences to target a class of relevant enzymes); sequences signaling selective degradation, of itself or co-bound proteins; and signal sequences capable of constitutively localizing the candidate expression products to a predetermined cellular locale, including a) subcellular locations such as the Golgi, endoplasmic reticulum, nucleus, nucleoli, nuclear membrane, mitochondria, chloroplast, secretory vesicles, lysosome, and cellular membrane; and b) extracellular locations via a secretory signal. Particularly preferred is localization to either subcellular locations.

The targeting moiety may be attached, for example, at any of the R positions of the chelator, to the polymer, to a linker (including a polymer that is a linker), or to a blocking moiety. Although in a preferred embodiment the targeting moiety does not replace a coordination atom.

In a preferred embodiment, the targeting moiety allows targeting of the imaging moiety of the invention to a particular tissue or the surface of a cell. That is, in a preferred embodiment the MRI contrast agents of the imaging moieties of the invention need not be taken up into the cytoplasm of a cell to be activated.

As will be appreciated by those in the art, the targeting moieties can be attached to the imaging moiety of the present invention, particularly the polymer or MRI contrast agent, in a large number of different ways, and in a variety of configurations.

In a preferred embodiment, the targeting moiety is a peptide. For example, chemotactic peptides have been used to image tissue injury and inflammation, particularly by bacterial infection; see WO 97/14443, hereby expressly incorporated by reference in its entirety.

In a preferred embodiment, the targeting moiety is an antibody. The term “antibody” includes antibody fragments, as are known in the art, including Fab Fab₂, single chain antibodies (Fv for example), chimeric antibodies, etc., either produced by the modification of whole antibodies or those synthesized de novo using recombinant DNA technologies.

In a preferred embodiment, the antibody targeting moieties of the invention are humanized antibodies or human antibodies. Humanized forms of non-human (e.g., murine) antibodies are chimeric immunoglobulins, immunoglobulin chains or fragments thereof (such as Fv, Fab, Fab′, F(ab′)2 or other antigen-binding subsequences of antibodies) which contain minimal sequence derived from non-human immunoglobulin. Humanized antibodies include human immunoglobulins (recipient antibody) in which residues from a complementary determining region (CDR) of the recipient are replaced by residues from a CDR of a non-human species (donor antibody) such as mouse, rat or rabbit having the desired specificity, affinity and capacity. In some instances, Fv framework residues of the human immunoglobulin are replaced by corresponding non-human residues. Humanized antibodies may also comprise residues which are found neither in the recipient antibody nor in the imported CDR or framework sequences. In general, the humanized antibody will comprise substantially all of at least one, and typically two, variable domains, in which all or substantially all of the CDR regions correspond to those of a non-human immunoglobulin and all or substantially all of the FR regions are those of a human immunoglobulin consensus sequence. The humanized antibody optimally also will comprise at least a portion of an immunoglobulin constant region (Fc), typically that of a human immunoglobulin [Jones et al., Nature 321:522-525 (1986); Riechmann et al., Nature 332:323-329 (1988); and Presta, Curr. Op. Struct. Biol. 2:593-596 (1992)].

Methods for humanizing non-human antibodies are well known in the art. Generally, a humanized antibody has one or more amino acid residues introduced into it from a source which is non-human. These non-human amino acid residues are often referred to as “import” residues, which are typically taken from an “import” variable domain. Humanization can be essentially performed following the method of Winter and co-workers [Jones et al., Nature 321:522-525 (1986); Riechmann et al., Nature 332:323-327 (1988); Verhoeyen et al., Science 239:1534-1536 (1988)], by substituting rodent CDRs or CDR sequences for the corresponding sequences of a human antibody. Accordingly, such “humanized” antibodies are chimeric antibodies (U.S. Pat. No. 4,816,567), wherein substantially less than an intact human variable domain has been substituted by the corresponding sequence from a non-human species. In practice, humanized antibodies are typically human antibodies in which some CDR residues and possibly some FR residues are substituted by residues from analogous sites in rodent antibodies.

Human antibodies can also be produced using various techniques known in the art, including phage display libraries [Hoogenboom and Winter, J. Mol. Biol. 227:381 (1991); Marks et al., J. Mol. Biol. 20, 222:581 (1991)]. The techniques of Cole et al. and Boerner et al. are also available for the preparation of human monoclonal antibodies (Cole et al., Monoclonal Antibodies and Cancer Therapy, Alan R. Liss, p. 77 (1985) and Boerner et al., J. Immunol. 147(1):86-95 (1991)]. Similarly, human antibodies can be made by introducing of human immunoglobulin loci into transgenic animals, e.g., mice in which the endogenous immunoglobulin genes have been partially or completely inactivated. Upon challenge, human antibody production is observed, which closely resembles that seen in humans in all respects, including gene rearrangement, assembly, and antibody repertoire. This approach is described, for example, in U.S. Pat. Nos. 5,545,807; 5,545,806; 5,569,825; 5,625,126; 5,633,425; 5,661,016, and in the following scientific publications: Marks et al., Bio/Technology 10:779-783 (1992); Lonberg et al., Nature 368:856-859 (1994); Morrison, Nature 368:812-13 (1994); Fishwild et al., Nature Biotechnology 14:845-51 (1996); Neuberger, Nature Biotechnology, 14:826 (1996); Lonberg and Huszar, Intern. Rev. Immunol. 13:65-93 (1995).

Bispecific antibodies are monoclonal, preferably human or humanized, antibodies that have binding specificities for at least two different antigens. In the present case, one of the binding specificities is for a first target molecule and the other one is for a second target molecule.

Methods for making bispecific antibodies are known in the art. Traditionally, the recombinant production of bispecific antibodies is based on the co-expression of two immunoglobulin heavy-chain/light-chain pairs, where the two heavy chains have different specificities [Milstein and Cuello, Nature 305:537-539 (1983)]. Because of the random assortment of immunoglobulin heavy and light chains, these hybridomas (quadromas) produce a potential mixture of ten different antibody molecules, of which only one has the correct bispecific structure. The purification of the correct molecule is usually accomplished by affinity chromatography steps. Similar procedures are disclosed in WO 93/08829, published 13 May 1993, and in Traunecker et al., EMBO J. 10:3655-3659 (1991).

Antibody variable domains with the desired binding specificities (antibody-antigen combining sites) can 10ii be fused to immunoglobulin constant domain sequences. The fusion preferably is with an immunoglobulin heavy-chain constant domain, comprising at least part of the hinge, CH2, and CH3 regions. It is preferred to have the first heavy-chain constant region (CHl) containing the site necessary for light-chain binding present in at least one of the fusions. DNAs encoding the immunoglobulin heavy-chain fusions and, if desired, the immunoglobulin light chain, are inserted into separate expression vectors, and are co-transfected into a suitable host organism. For further details of generating bispeciflc antibodies see, for example, Suresh et al., Methods in Enzymology 121:210 (1 986).

Heteroconjugate antibodies are also within the scope of the present invention. Heteroconjugate antibodies are composed of two covalently joined antibodies. Such antibodies have, for example, been proposed to target immune system cells to unwanted cells [U.S. Pat. No. 4,676,980], and for treatment of HIV infection [WO 91/00360; WO 92/200373; EP 03089]. It is contemplated that the antibodies may be prepared in vitro using known methods in synthetic protein chemistry, including those involving crosslinking agents. For example, immunotoxins may be constructed using a disulfide exchange reaction or by forming a thioether bond. Examples of suitable reagents for this purpose include iminothiolate and methyl-4-mercaptobutyrimidate and those disclosed, for example, in U.S. Pat. No. 4,676,980.

In a preferred embodiment, the antibody is directed against a cell-surface marker on a cancer cell; that is, the target molecule is a cell surface molecule. As is known in the art, there are a wide variety of antibodies known to be differentially expressed on tumor cells, including, but not limited to, HER2, VEGF, etc.

In one embodiment, antibodies against virus or bacteria can be used as targeting moieties. As will be appreciated by those in the art, antibodies to any number of viruses (including orthomyxoviruses, (e.g. influenza virus), paramyxoviruses (e.g respiratory syncytial virus, mumps virus, measles virus), adenoviruses, rhinoviruses, coronaviruses, reoviruses, togaviruses (e.g. rubella virus), parvoviruses, poxviruses (e.g. variola virus, vaccinia virus), enteroviruses (e.g. poliovirus, coxsackievirus), hepatitis viruses (including A, B and C), herpesviruses (e.g. Herpes simplex virus, varicella-zoster virus, cytomegalovirus, Epstein-Barr virus), rotaviruses, Norwalk viruses, hantavirus, arenavirus, rhabdovirus (e.g. rabies virus), retroviruses (including HIV, HTLV-I and -II), papovaviruses (e.g. papillomavirus), polyomaviruses, and picornaviruses, and the like), and bacteria (including a wide variety of pathogenic and non-pathogenic prokaryotes of interest including Bacillus; Vibrio, e.g. V cholerae; Escherichia, e.g. Enterotoxigenic E. coli, Shigella, e.g. S. dysenteriae; Salmonella, e.g. S. typhi; Mycobacterium e.g. M. tuberculosis, M. leprae; Clostridium, e.g. C. botulinum, C. tetani, C. difficile, C.perfringens; Cornyebacterium, e.g. C. diphtheriae; Streptococcus, S. pyogenes, S. pneumoniae; Staphylococcus, e.g. S. aureus; Haemophilus, e.g. H. influenzae; Neisseria, e.g. N. meningitidis, N. gonorrhoeae; Yersinia, e.g. G. lambliaY. pestis, Pseudomonas, e.g. P. aeruginosa, P. putida; Chlamydia, e.g. C. trachomatis; Bordetella, e.g. B. pertussis; Treponema, e.g. T. palladium; and the like) may be used.

In addition, antibodies against physiologically relevant carbohydrates may be used, including, but not limited to, antibodies against markers for breast cancer (CA15-3, CA 549, CA 27.29), mucin-like carcinoma associated antigen (MCA), ovarian cancer (CA125), pancreatic cancer (DE-PAN-2), and colorectal and pancreatic cancer (CA 19, CA 50, CA242).

In a preferred embodiment, the targeting moiety is all or a portion (e.g. a binding portion) of a ligand for a cell surface receptor. Suitable ligands include, but are not limited to, all or a functional portion of the ligands that bind to a cell surface receptor selected from the group consisting of insulin receptor (insulin), insulin-like growth factor receptor (including both IGF-1 and IGF-2), growth hormone receptor, glucose transporters (particularly GLUT 4 receptor), transferrin receptor (transferrin), epidermal growth factor receptor (EGF), low density lipoprotein receptor, high density lipoprotein receptor, leptin receptor, estrogen receptor (estrogen); interleukin receptors including IL-1, IL-2, IL-3, IL-4, IL-5, IL-6, IL-7, IL-8, IL-9, IL-11, IL-12, IL-13, IL-15, and IL-17 receptors, human growth hormone receptor, VEGF receptor (VEGF), PDGF receptor (PDGF), transforming growth factor receptor (including TGF-α and TGF-β), EPO receptor (EPO), TPO receptor (TPO), ciliary neurotrophic factor receptor, prolactin receptor, and T-cell receptors. In particular, hormone ligands are preferred. Hormones include both steroid hormones and proteinaceous hormones, including, but not limited to, epinephrine, thyroxine, oxytocin, insulin, thyroid-stimulating hormone, calcitonin, chorionic gonadotropin, cortictropin, follicle-stimulating hormone, glucagon, leuteinizing hormone, lipotropin, melanocyte-stimutating hormone, norepinephrine, parathryroid hormone, thyroid-stimulating hormone (TSH), vasopressin, enkephalins, seratonin, estradiol, progesterone, testosterone, cortisone, and 35 glucocorticoids and the hormones listed above. Receptor ligands include ligands that bind to receptors such as cell surface receptors, which include hormones, lipids, proteins, glycoproteins, signal transducers, growth factors, cytokines, and others.

In a preferred embodiment, the targeting moiety is a carbohydrate. By “carbohydrate” herein is meant a compound with the general formula Cx(H2O)y. Monosaccharides, disaccharides, and oligo- or polysaccharides are all included within the definition and comprise polymers of various sugar molecules linked via glycosidic linkages. Particularly preferred carbohydrates are those that comprise all or part of the carbohydrate component of glycosylated proteins, including monomers and oligomers of galactose, mannose, fucose, galactosamine, (particularly N-acetylglucosamine), glucosamine, glucose and sialic acid, and in particular the glycosylation component that allows binding to certain receptors such as cell surface receptors. Other carbohydrates comprise monomers and polymers of glucose, ribose, lactose, raffinose, fructose, and other biologically significant carbohydrates. In particular, polysaccharides (including, but not limited to, arabinogalactan, gum arabic, mannan, etc.) have been used to deliver MR[ contrast agents into cells; see U.S. Pat. No. 5,554,386, hereby incorporated by reference in its entirety.

In a preferred embodiment, the targeting moiety is a lipid. “Lipid” as used herein includes fats, fatty oils, waxes, phospholipids, glycolipids, terpenes, fatty acids, and glycerides, particularly the triglycerides. Also included within the definition of lipids are the eicosanoids, steroids and sterols, some of which are also hormones, such as prostaglandins, opiates, and cholesterol.

In addition, as will be appreciated by those in the art, any moiety which may be utilized as a blocking moiety can be used as a targeting moiety. Particularly preferred in this regard are enzyme inhibitors, as they will not be cleaved off and will serve to localize the MRI contrast agent in the location of the enzyme.

In a preferred embodiment, the targeting moiety may be used to either allow the internalization of the MRI contrast agent to the cell cytoplasm or localize it to a particular cellular compartment, such as the nucleus.

In a preferred embodiment, the targeting moiety is all or a portion of the HIV-1 Tat protein, and analogs and related proteins, which allows very high uptake into target cells. See for example, Fawell et al., PNAS USA 91:664 (1994); Frankel et al., Cell 55:1189 (1988); Savion et al., J. Biol. Chem. 256:1149 (1981); Derossi et al., J. Biol. Chem. 269:10444 (1994); and Baldin et al., EMBO J. 9:1511 (1990), all of which are incorporated by reference.

In a preferred embodiment, the targeting moiety is a nuclear localization signal (NLS). NLSs are generally short, positively charged (basic) domains that serve to direct the moiety to which they are attached to the cell's nucleus. Numerous NLS amino acid sequences have been reported including single basic NLS's such as that of the SV40 (monkey virus) large T Antigen (Pro Lys Lys Lys Arg Lys Val), Kalderon (1984), et al., Cell, 39:499-509; the human retinoic acid receptor-β nuclear localization signal (ARRRRP); NF_{K}B p50 (EEVQRKRQKL; Ghosh et al., Cell 62:1019 (1990); NF_{K}B p65 (EEKRKRTYE; Nolan et al., Cell 64:961 (1991); and others (see for example Boulikas, J. Cell. Biochem. 55(1):32-58 (1994), hereby incorporated by reference) and double basic NLS's exemplified by that of the Xenopus (African clawed toad) protein, nucleoplasmin (Ala Val Lys Arg Pro Ala Ala Thr Lys Lys Ala Gly Gln Ala Lys Lys Lys Lys Leu Asp), Dingwall, et al., Cell, 30:449-458, 1982 and Dingwall, et al., J. Cell Biol., 107:641-849; 1988). Numerous localization studies have demonstrated that NLSs incorporated in synthetic peptides or grafted onto reporter proteins not normally targeted to the cell nucleus cause these peptides and reporter proteins to be concentrated in the nucleus. See, for example, Dingwall, and Laskey, Ann, Rev. Cell Biol., 2:367-390, 1986; Bonnerot, et al., Proc. Natl. Acad. Sci. USA, 84:6795-6799, 1987; Galileo, et al., Proc. Nat]. Acad. Sci. USA, 87:458-462, 1990.

In a preferred embodiment, targeting moieties for the hepatobiliary system are used; see U.S. Pat. Nos. 5,573,752 and 5,582,814, both of which are hereby incorporated by reference in their entirety.

Another class of suitable substitution groups are chemical functional groups that are used to add the components of the invention together, as is more fully outlined below. Thus, in general, the components of the invention are attached through the use of functional groups on each that can then be used for attachment. Preferred functional groups for attachment are amino groups, carboxy groups, oxo groups and thiol groups. These functional groups can then be attached, either directly or indirectly through the use of a linker. Linkers are well known in the art; for example, homo-or hetero-bifunctional linkers as are well known (see 1994 Pierce Chemical Company catalog, technical section on cross-linkers, pages 155-200, incorporated herein by reference). Preferred linkers include, but are not limited to, alkyl groups (including substituted alkyl groups and alkyl groups containing heteroatom moieties), with short alkyl groups, esters, amide, amine, epoxy groups, nucleic acids, peptides and ethylene glycol and derivatives being preferred.

The substitution group may also be hydrogen or a therapeutic blocking moiety, as is described above.

What is important is that the metal ion complex, comprising the metal ion, the chelator and the therapeutic blocking moiety, is not readily able to rapidly exchange water molecules when the therapeutic moeities are in the inner coordination sphere of the metal ion, such that in the presence of the therapeutic blocking moiety, there is less or little substantial image enhancement.

In a preferred embodiment, the physiological target protein is an enzyme. As will be appreciated by those skilled in the art, the possible enzyme target substances are quite broad. Suitable classes of enzymes include, but are not limited to, hydrolases such as proteases, carbohydrases, lipases and nucleases; isomerases such as racemases, epimerases, tautomerases, or mutases; transferases, kinases and phophatases. Enzymes associated with the generation or maintenance of arterioschlerotic plaques and lesions within the circulatory system, inflammation, wounds, immune response, tumors, apoptosis, exocytosis, etc. may all be treated using the present invention. Enzymes such as lactase, maltase, sucrase or invertase, cellulase, α-amylase, aldolases, glycogen phosphorylase, kinases such as hexokinase, proteases such as serine, cysteine, aspartyl and metalloproteases may also be detected, including, but not limited to, trypsin, chymotrypsin, and other therapeutically relevant serine proteases such as tPA and the other proteases of the thrombolytic cascade; cysteine proteases including: the cathepsins, including cathepsin B, L, S, H, J, N and O; and calpain; and caspases, such as caspase-3, -5, -8 and other caspases of the apoptotic pathway, such as interleukin-converting enzyme (ICE). Similarly, bacterial and viral infections may be detected via characteristic bacterial and viral enzymes. As will be appreciated in the art, this list is not meant to be limiting.

Once the target enzyme is identified or chosen, enzyme inhibitor therapeutically active agents can be designed using well known parameters of enzyme substrate specificities. As described above, the inhibitor may be another metal ion complex such as the cobalt complexes described above. Other suitable enzyme inhibitors include, but are not limited to, the cysteine protease inhibitors described in PCT US95/02252, PCT/US96/03844 and PCT/US96/08559, and known protease inhibitors that are used as drugs such as inhibitors of HIV proteases.

In one embodiment, the therapeutically active agent is a nucleic acid, for example to do gene therapy or antisense therapy. By “nucleic acid” or “oligonucleotide” or grammatical equivalents herein means at least two nucleotides covalently linked together. A nucleic acid of the present invention will generally contain phosphodiester bonds, although in some cases, as described below, nucleic acid analogs are included that may have alternate backbones, comprising, for example, phosphoramide (Beaucage et al., Tetrahedron 49(10):1925 (1993) and references therein; Letsinger, J. Org. Chem. 35:3800 (1970); Sprinzl et al., Eur. J. Biochem. 81:579 (1977); Letsinger et al., Nucl. Acids Res. 14:3487 (1986); Sawai et al, Chem. Lett. 805 (1984), Letsingeret al., J. Am. Chem. Soc. 110:4470 (1988); and Pauwels et al., Chemica Scripta 26:141 91986)), phosphorothioate (Mag et al., Nucleic Acids Res. 19:1437 (1991); and U.S. Pat. No. 5,644,048), phosphorodithioate (Briu et al., J. Am. Chem. Soc. 111:2321 (1989), O-methylphophoroamidite linkages (see Eckstein, Oligonucleotides and Analogues: A Practical Approach, Oxford University Press), and peptide nucleic acid backbones and linkages (see Egholm, J. Am. Chem. Soc. 114:1895 (1992); Meier et al., Chem. Int. Ed. Engl. 31:1008 (1992); Nielsen, Nature, 365:566 (1993); Carlsson et al., Nature 380:207 (1996), all of which are incorporated by reference). Other analog nucleic acids include those with positive backbones (Denpcy et al., Proc. Natl. Acad. Sci. USA 92:6097 (1995); non-ionic backbones (U.S. Pat. Nos. 5,386,023, 5,637,684, 5,602,240, 5,216,141 and 4,469,863; Kiedrowshi et al., Angew. Chem. Intl. Ed. English 30:423 (1991); Letsinger et al., J. Am. Chem. Soc. 110:4470 (1988); Letsinger et al., Nucleoside & Nucleotide 13:1597 (1994); Chapters 2 and 3, ASC Symposium Series 580, “Carbohydrate Modifications in Antisense Research”, Ed. Y. S. Sanghui and P. Dan Cook; Mesmaeker et al., Bioorganic & Medicinal Chem. Lett. 4:395 (1994); Jeffs et al., J. Biomolecular NMR 34:17 (1994); Tetrahedron Lett. 37:743 (1996)) and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins et al., Chem. Soc. Rev. (1995) pp 169-176). Several nucleic acid analogs are described in Rawls, C & E News Jun. 2, 1997 page 35. All of these references are hereby expressly incorporated by reference. These modifications of the ribose-phosphate backbone may be done to increase the stability and half-life of such molecules in physiological environments; for example, PNA antisense embodiments are particularly preferred.

As will be appreciated by those in the art, all of these nucleic acid analogs may find use in the present invention. In addition, mixtures of naturally occurring nucleic acids and analogs can be made or mixtures of different nucleic acid analogs.

The nucleic acid may be single-stranded or double stranded. The physiological target molecule can be a substantially complementary nucleic acid or a nucleic acid binding moiety, such as a protein.

In a preferred embodiment, the physiological target substance is a physiologically active ion, and the therapeutically active agent is an ion binding ligand or chelate. For example, toxic metal ions could be chelated to decrease toxicity, using a wide variety of known chelators including, for example, crown ethers.

In addition to the therapeutically active agents and coordination site barriers, a therapeutic blocking moiety may also comprise a cleavage site or cleavable linkage. As described herein, one way of delivering the therapeutically active agent is to cleave it off the MRI contrast agent. It is also possible to configure the MRI contrast agents of the invention such that a coordination site barrier is cleaved off, leaving the therapeutically active agent attached to the MRI contrast agent, but in a conformation wherein the drug is now able to interact with its target in a way it was not able to prior to cleavage. In some embodiments, the coordination atom(s) that hinder the rapid exchange of water at a coordination site may be contributed by the cleavage site. Thus for example, when a proteolytic cleavage site is used, coordination atoms may be provided by an atom of the peptide chain.

In a preferred embodiment, the physiological target is an enzyme and the cleavage site corresponds to that enzyme. Alternatively, the cleavage site is unrelated to the physiological target. In this embodiment, the cleavage site may be either specific to a disease condition, for example the cleavage site may be an HIV protease site and the therapeutically active agent is chosen to interfere with a different viral function (for example viral replication), or it may be non-specific, relying instead on a different mechanism for specificity, if desired. For example, the cleavage site may be a “generic” intracellular protease site, and specificity can be provided by a targeting moiety attached to the MRI contrast agent; for example, a cell-specific ligand could be used to target a specific set of cells such as tumor cells.

Thus, for example, a proteolytic cleavage site may be used for cleavage by proteases. The cleavage site thus comprises a peptide or polypeptide that is capable of being cleaved by a defined protease. By “peptide” or “polypeptide” herein is meant a compound of about 2 to about 15 amino acid residues covalently linked by peptide bonds. Preferred embodiments utilize polypeptides from about 2 to about 8 amino acids, with about 2 to about 4 being the most preferred. Preferably, the amino acids are naturally occurring amino acids, although amino acid analogs and peptidomimitic structures are also useful. Under certain circumstances, the peptide may be only a single amino acid residue.

Preferred protease cleavage sites and cognate proteases include, but are not limited to, prosequences of retroviral proteases including human immunodeficiency virus protease, and sequences recognized and cleaved by trypsin (EP 578472), Takasuga, A. et al. (1992) J. Biochem. 112: 652-57), proteases encoded by Picornaviruses (Ryan, M. D. et al. (1997) J. Gen. Virol. 78: 699-723), factor Xₐ (Gardella, T. J. et al. (1990) J. Biol. Chem. 265: 15854-59; WO 9006370), collagenase (J03280893; WO 9006370; Tajima, S. et al. (1991) J. Ferment. Bioeng. 72: 362), clostripain (EP 578472), subtilisin (including mutant H64A subtilisin, Forsberg, G. et al. (1991) J. Protein Chem. 10: 517-26), chymosin, yeast KEX2 protease (Bourbonnais, Y. et al. (1988) J. Bio. Chem. 263: 15342-47), thrombin (Forsberg et al., supra; Abath, F. G. et al. (1991) BioTechniques 10: 178), Staphylococcus aureus V8 protease or similar endoproteinase-Glu-C to cleave after Glu residues (EP 578472; Ishizaki, J. et al. (1992) Appl. Microbiol. Biotechnol. 36: 483-86), cleavage by NIa proteinase of tobacco etch virus (Parks, T. D. et al. (1994) Anal. Biochem. 216: 413-17), endoproteinase-Lys-C (U.S. Pat. No. 4,414,332) and endoproteinase-Asp-N, Neisseria type 2 IgA protease (Pohiner, J. et al. (1992) Biotechnology 10: 799-804), soluble yeast endoproteinase yscF (EP 467839), chymotrypsin (Altman, J. D. et al. (1991) Protein Eng. 4: 593-600), enteropeptidase (WO 9006370), lysostaphin, a polyglycine specific endoproteinase (EP 316748), the family of caspases (i.e. caspase 1, caspase 2, capase 3, etc.), and metalloproteases.

Similarly, when the enzyme is a carbohydrase, the cleavage site will be a carbohydrate group which is capable of being cleaved by the target carbohydrase. For example, when the enzyme is lactase or β-galactosidase, the cleavage site is lactose or galactose. Similar pairs include sucrase/sucrose, maltase/maltose, and α-amylase/amylose.

In a preferred embodiment, the cleavage site is a phosphorus moiety, as defined above, such as —(OPO(OR₂))ₙ, wherein n is an integer from 1 to about 10, with from 1 to 5 being preferred and 1 to 3 being particularly preferred. Each R is independently hydrogen or a substitution group as defined herein, with hydrogen being preferred. This embodiment is particularly useful when the cleavage enzyme is alkaline phosphatase or a phosphodiesterase, or other enzymes known to cleave phosphorus containing moieties such as these.

In addition to the components described above, it should be appreciated that the therapeutic blocking moieties of the present invention may further comprise a linker group as well as a functional therapeutic blocking moiety. Again, as described herein for the therapeutically active agents and the cleavage sites, a coordination atom may actually be provided by the linker.

Accordingly, the therapeutic blocking moieties of the invention include a therapeutically active agent and optional cleavage sites, coordination site barriers, and linkers, if required.

In some embodiments, the metal ion complexes of the invention have a single associated or bound therapeutic blocking moiety. In such embodiments, the single therapeutic blocking moiety impedes the exchange of water molecules in at least one coordination site. Alternatively, as is described below, a single therapeutic blocking moiety may hinder the exchange of water molecules in more than one coordination site.

In alternative embodiments, two or more therapeutic blocking moieties are associated with a single metal ion complex, to implede the exchange of water in at least one or more coordination sites.

The therapeutic blocking moiety is attached to the metal ion complex in a variety of ways. In a preferred embodiment, as noted above, the therapeutic blocking moiety is attached to the metal ion complex via a linker group. Alternatively, the therapeutic blocking moiety is attached directly to the metal ion complex; for example, as described below, the therapeutic blocking moiety may be a substituent group on the chelator.

In a preferred embodiment at least one of the R groups attached to the “arms” of the chelator, for example R₉, R₁₀, R₁₁, or R₁₂ of the DOTA structures, or R₁₃, R₁₄, R₁₇, R₂₀ or R₂₁ of the DTPA structures, comprises an alkyl (including substituted and heteroalkyl groups), or aryl (including substituted and heteroaryl groups), i.e. is a group sterically bulkier than hydrogen. This is particular useful to drive the equilibrium towards “locking” the coordination atom of the arm into place to prevent water exchange, as is known for standard MRI contrast agents. Preferred groups include the C1 through C6 alkyl groups with methyl being particularly preferred.

This is particularly preferred when the therapeutic blocking moiety is attached via one of the “arms”, for example when a therapeutic blocking moiety is at position X₁ to X₄ (Structure 20), or position H, I, J or K of Structure 21.

However the inclusion of too many groups may drive the equilibrium in the other direction effectively locking the coordination atom out of position. Therefore in a preferred embodiment only 1 or 2 of these positions is a non-hydrogen group, unless other methods are used to drive the equilibrium towards binding.

The therapeutic blocking moieties are chosen and designed using a variety of parameters. In the embodiment which uses a coordination site barrier and the coordination site barrier is fastened or secured on two sides, the affinity of the coordination site barrier of the therapeutic blocking moiety for the metal ion complex need not be great, since it is tethered in place. That is, in this embodiment, the complex is “off” in the absence of the cleavage agent. However, in the embodiment where the therapeutic blocking moiety is linked to the complex in such a manner as to allow some rotation or flexibility of the therapeutic blocking moiety, for example, it is linked on one side only, the therapeutic blocking moiety should be designed such that it occupies the coordination site a majority of the time.

When the therapeutic blocking moiety is not covalently tethered on two sides, it should be understood that the components of the therapeutic blocking moieties are chosen to maximize three basic interactions that allow the therapeutic blocking moiety to be sufficiently associated with the complex to hinder the rapid exchange of water in at least one coordination site of the complex. First, there may be electrostatic interactions between the therapeutic blocking moiety and the metal ion, to allow the therapeutic blocking moiety to associate with the complex. Secondly, there may be Van der Waals and dipole-dipole interactions. Thirdly, there may be ligand interactions, that is, one or more functionalities of the therapeutic blocking moiety may serve as coordination atoms for the metal. In addition, linker groups may be chosen to force or favor certain conformations, to drive the equilibrium towards an associated therapeutic blocking moiety. Similarly, removing degrees of freedom in the molecule may force a particular conformation to prevail. Thus, for example, the addition of alkyl groups, and particularly methyl groups, at positions equivalent to the R₉ to R₁₂ positions of structure 20 when the therapeutic blocking moiety is attached at an “X” position can lead the therapeutic blocking moiety to favor the blocking position. Similar restrictions can be made in the other embodiments, as will be appreciated by those in the art.

Furthermore, effective “tethering” of the therapeutic blocking moiety down over the metal ion may also be done by engineering in other non-covalent interactions that will serve to increase the affinity of the therapeutic blocking moiety to the chelator complex, as is depicted below.

Potential therapeutic blocking moieties may be easily tested to see if they are functional; that is, if they sufficiently occupy or block the appropriate coordination site or sites of the complex to prevent rapid exchange of water. Thus, for example, complexes are made with potential therapeutic blocking moieties and then compared with the chelator without the therapeutic blocking moiety in imaging experiments. Once it is shown that the therapeutic blocking moiety is a sufficient “blocker”, the experiments are repeated in the presence of either the physiological target (when it is the interaction of the target and the drug which causes either cleavage or a conformational change resulting in opening up of a coordination site) or the cleavage agent, to show an increase in the exchange of water and thus enhancement of the image.

Thus, as described above, the metal ion complexes of the present invention comprise a paramagnetic metal ion bound to a chelator and at least one therapeutic blocking moiety. In a preferrred embodiment, the metal ion complexes have the formula shown in Structure 20:

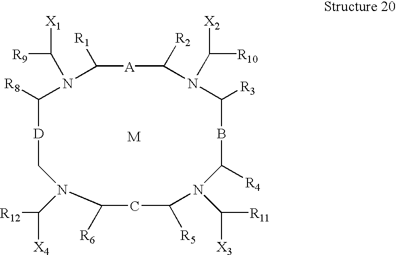

In Structure 20, M is a paramagnetic metal ion selected from the group consisting of Gd(III), Fe(III), Mn(II), Yt(III), and Dy(III). A, B, C and D are each either single or double bonds. The R₁ through R₁₂ groups are substitution groups as defined above, including therapeutic blocking moieties and targeting moieties. X₁ through X₄ are —OH, —COO—, —(CH2)ₙOH (with —CH₂OH being preferred), —(CH2)ₙCOO—(with CH₂COO— being preferred), or a substitution group, including therapeutic blocking moieties and targeting moieties. n is from 1 to 10, with from 1 to 5 being preferred. At least one of R₁ to R₁₂ and X₁ to X₄ is a therapeutic blocking moiety.

In the Structures depicted herein, any or all of A, B, C or D may be a single bond or a double bond. It is to be understood that when one or more of these bonds are double bonds, there may be only a single substitutent group attached to the carbons of the double bond. For example, when A is a double bond, there may be only a single R₁ and a single R₂ group attached to the respective carbons; in a preferred embodiment, as described below, the R₁ and R₂ groups are hydrogen. In a preferred embodiment, A is a single bond, and it is possible to have two R₁ groups and two R₂ groups on the respective carbons. In a preferred embodiment, these groups are all hydrogen with the exception of a single therapeutic blocking moiety, but alternate embodiments utilize two R groups which may be the same or different. That is, there may be a hydrogen and a therapeutic group attached in the R₁ position, and two hydrogens, two alkyl groups, or a hydrogen and an alkyl group in the R₂ positions.

It is to be understood that the exact composition of the X₁-X₄ groups will depend on the presence of the metal ion. That is, in the absence of the metal ion, the groups may be —OH, —COOH, —(CH₂)ₙOH, or (CH₂)ₙCOOH; however, when the metal is present, the groups may be —OH, —COO—, —(CH₂)ₙO—, or (CH₂)ₙCOO—.

A further embodiment utilizes metal ion complexes having the formula shown in Structure 21:

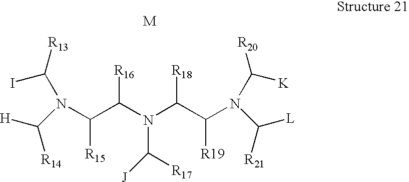

It is to be understood that, as above, the exact composition of the H, I, J, K and L groups will depend on the presence of the metal ion. That is, in the absence of the metal ion, H, I, J, K and L are —OH, —COOH, —(CH₂)ₙOH, or (CH₂)ₙCOOH; however, when the metal is present, the groups are —OH, —COO—, —(CH₂)ₙOH, or (CH2)ₙCOO—.

In this embodiment, R₁₃ through R₂₁ are substitution groups as defined above. In a preferred embodiment, R₁₂ to R₂₁ are hydrogen. At least one of R₁₃-R₂₁, H, I, J, K or L is a therapeutic blocking moiety, as defined above.

In addition, the complexes and metal ion complexes of the invention may further comprise one or more targeting moieties. That is, a targeting moiety may be attached at any of the R positions (or to a linker or therapeutic blocking moiety, etc.), although in a preferred embodiment the targeting moiety does not replace a coordination atom.

In a preferred embodiment, the metal ion complexes of the present invention are water soluble or soluble in aqueous solution. By “soluble in aqueous solution” herein is meant that the MRI contrast agent has appreciable solubility in aqueous solution and other physiological buffers and solutions. Solubility may be measured in a variety of ways. In one embodiment, solubility is measured using the United States Pharmacopeia solubility classifications, with the metal ion complex being either very soluble (requiring less than one part of solvent for 1 part of solute), freely soluble (requiring one to ten parts solvent per 1 part solute), soluble (requiring ten to thirty parts solvent per 1 part solute), sparingly soluble (requiring 30 to 100 parts solvent per 1 part solute), or slightly soluble (requiring 100-1000 parts solvent per 1 part solute).

Testing whether a particular metal ion complex is soluble in aqueous solution is routine, as will be appreciated by those in the art. For example, the parts of solvent required to solubilize a single part of MRI contrast agent may be measured, or solubility in gm/mi may be determined.

The complexes of the invention are generally synthesized using well known techniques. See, for example, Moi et al., supra; Tsien et al., supra; Borch et al., J. Am. Chem. Soc., p2987 (1971);

Alexander, (1995), supra; Jackels (1990), supra, U.S. Pat. Nos. 5,155,215, 5,087,440, 5,219,553, 5,188,816, 4,885,363, 5,358,704, 5,262,532; Meyer et al., (1990), supra, Moi et al., (1988), and McMurray et al., Bioconjugate Chem. 3(2):108-117 (1992)).

For DOTA derivatives, the synthesis depends on whether nitrogen substitution or carbon substitution of the cyclen ring backbone is desired. For nitrogen substitution, such as is exemplified by the galactose-DOTA structures of the examples, the synthesis begins with cyclen or cyclen derivatives, as is well known in the art; see for example U.S. Pat. Nos. 4,885,363 and 5,358,704.

For carbon substitution, such as is exemplified by the BAPTA-DOTA structures of the examples, well known techniques are used. See for example Moi et al., supra, and Gansow, supra.

The contrast agents of the invention are complexed with the appropriate metal ion as is known in the art. While the structures depicted herein all comprise a metal ion, it is to be understood that the contrast agents of the invention need not have a metal ion present initially. Metal ions can be added to water in the form of an oxide or in the form of a halide and treated with an equimolar amount of a contrast agent composition. The contrast agent may be added as an aqueous solution or suspension. Dilute acid or base can be added if need to maintain a neutral pH. Heating at temperatures as high as 100° C. may be required.

The complexes of the invention can be isolated and purified, for example using HPLC systems.

Pharmaceutical compositions comprising pharmaceutically acceptable salts of the contrast agents can also be prepared by using a base to neutralize the complexes while they are still in solution. Some of the complexes are formally uncharged and do not need counterions.

In addition, the MRI contrast agents of the invention can be added to polymers, using techniques generally described in PCT US95/14621 and U.S. Ser. No. 08/690,612 (allowed), both of which are expressly incorporated by reference. Briefly, chemical functional groups are added to the MRI contrast agents to allow the chemical attachment of a plurality of MRI contrast agents to polymers. A “polymer” comprises at least two or three subunits, which are covalently attached. At least some portion of the monomeric subunits contain functional groups for the covalent attachment of the MRI contrast agents. In some embodiments coupling moieties are used to covalently link the subunits with the MRI contrast agents. As will be appreciated by those in the art, a wide variety of polymers are possible. Suitable polymers include functionalized styrenes, such as amino styrene, functionalized dextrans, and polyamino acids. Preferred polymers are polyamino acids (both poly-D-amino acids and poly-L-amino acids), such as polylysine, and polymers containing lysine and other amino acids being particularly preferred. Other suitable polyamino acids are polyglutamic acid, polyaspartic acid, co-polymers of lysine and glutamic or aspartic acid, co-polymers of lysine with alanine, tyrosine, phenylalanine, serine, tryptophan, and/or proline.

Similarly, it is also possible to create “multimers” of MRI contrast agents, by either direct attachment or through the use of linkers as is generally described in U.S. Ser. No. 08/690,612 (allowed), incorporated by reference.

Once synthesized, the metal ion complexes of the invention have use as magnetic resonance imaging contrast or enhancement agents. Specifically, the functional MRI contrast agents of the invention have several important uses. First, they may be used to diagnose disease states of the brain, as is described below. Second, they may be used in real-time detection and differentiation of myocardial infraction versus ischemia. Third, they may be used in in vivo, i.e. whole organism, investigation of antigens and immunocytochemistry for the location of tumors. Fourth, they may be used in the identification and localization of toxin and drug binding sites. In addition, they may be used to perform rapid screens of the physiological response to drug therapy.

The metal ion complexes of the invention may be used in a similar manner to the known gadolinium MRI contrast agents. See for example, Meyer et al., supra; U.S. Pat. No. 5,155,215; U.S. Pat. No. 5,087,440; Margerstadt et al., Magn. Reson. Med. 3:808 (1986); Runge et al., Radiology 166:835 (1988); and Bousquet et al., Radiology 166:693 (1988). The metal ion complexes are administered to a cell, tissue or patient as is known in the art. A “patient” for the purposes of the present invention includes both humans and other animals and organisms, such as experimental animals. Thus the methods are applicable to both human therapy and veterinary applications. In addition, the metal ion complexes of the invention may be used to image tissues or cells; for example, see Aguayo et al., Nature 322:190 (1986).

Generally, sterile aqueous solutions of the contrast agent complexes of the invention are administered to a patient in a variety of ways, including orally, intrathecally and especially intraveneously in concentrations of 0.003 to 1.0 molar, with dosages from 0.03, 0.05, 0.1, 0.2, and 0.3 millimoles per kilogram of body weight being preferred. Dosages may depend on the structures to be imaged. Suitable dosage levels for similar complexes are described in U.S. Pat. Nos. 4,885,363 and 5,358,704.

In addition, the contrast agents of the invention may be delivered via specialized delivery systems, for example, within liposomes (see Navon, Magn. Reson. Med. 3:876-880 (1986)) or microspheres, which may be selectively taken up by different organs (see U.S. Pat. No. 5,155,215).

In some embodiments, it may be desirable to increase the blood clearance times (or half-life) of the MRI contrast agents of the invention. This has been done, for example, by adding carbohydrate polymers to the chelator (see U.S. Pat. No. 5,155,215). Thus, one embodiment utilizes polysaccharides as substitution R groups on the compositions of the invention.

A preferred embodiment utilizes complexes which cross the blood-brain barrier. Thus, as is known in the art, a DOTA derivative which has one of the carboxylic acids replaced by an alcohol to form a neutral DOTA derivative has been shown to cross the blood-brain barrier. Thus, for example, neutral complexes are designed that cross the blood-brain barrier with blocking moieties which detect Ca+2 ions. These compounds are used in MRI of a variety of neurological disorders, including Alzeheimer's disease. Currently it is difficult to correctly diagnosis Alzeheimer's disease, and it would be useful to be able to have a physiological basis to distinguish Alzeheimer's disease from depression, or other treatable clinical symptoms for example.

In a preferred embodiment, the therapeutic moiety is attached to the chelate using a photocleavable moiety as defined on the next page. Also included in the photocleavable moieties are guinone derivatives. Also included are WO99/25389, PCT US/9822743, hereby incorporated by reference.

In the imaging moieties of the present invention, the cleavable linkage that links an MRI contrast agent to the polymer can be any of the cleavage linkages, cleavable linkers, or cleavable sites described herein, for example, an enzyme cleavage site. In preferred embodiments, the cleavable linkage is a protease cleavage site or an ester linkage as described herein. The cleavable linkage may be attached to the MRI contrast agent and polymer using methods described herein or known in the art.

The references cited herein are expressly incorporated by reference.

We claim:

1. An imaging moiety comprising a polymer and a plurality of MRI contrast agents each linked to said polymer by a cleavable linkage, wherein at least one of said MRI contrast agents comprises:
a) a paramagnetic metal ion capable of binding n coordination atoms, wherein said metal ion is bound to a chelator such that said metal ion has coordination atoms at (n-1) or (n-2) coordination sites of said metal ion; and
b) a blocking moiety covalently attached to said chelator which hinders the rapid exchange of water in the remaining coordination site or sites;
wherein said blocking moiety is capable of interacting with a target substance such that the exchange of water in said remaining coordination sites is increased.

2. The imaging moiety according to claim 1, wherein at least one of said MRI contrast agents has the formula: 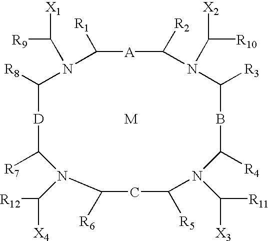
wherein
M is a paramagnetic metal ion selected from the group consisting of Gd(III), Fe(III), Mn(II), Yt(III), Cr(III) and Dy(III);
A, B, C and D are either single bonds or double bonds;
X₁, X₂, X₃ and X₄ are —OH, —COO—, —CH₂OH—CH₂COO—, or a blocking moiety;
R₁-R₁₂ each comprise a hydrogen, alkyl, aryl, alcohol, amine, amido, nitro, ether, ester, ketone, imino, aldehyde, alkoxy, carbonyl, halogen, sulfur containing moiety, phosphorus containing moiety, blocking moiety, targeting moiety, or, together with an adjacent R group comprise an alkyl or aryl group;
wherein at least one of R₁-R₁₂ further comprises said cleavable linkage; and
wherein at least one of X₁-X₄ and R₁-R₁₂ is a blocking moiety.

3. The imaging moiety according to claim 1, wherein at least one of said MRI contrast agents has the formula: 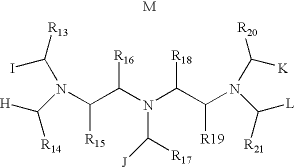
wherein
M is a paramagnetic metal ion selected from the group consisting of Gd(III), Fe(III), Mn(II), Yt(III), Cr(III) or Dy(III);
H, I, J, K and L are —OH, —COO—, —CH2OH, —CH2COO—, or a blocking moiety;
R₁₃-R₂₁ each comprise a hydrogen, alkyl, aryl, alcohol, amine, amido, nitro, ether, ester, ketone, imino, aldehyde, alkoxy, carbonyl, halogen, sulfur containing moiety, phosphorus containing moiety, blocking moiety, targeting moiety, or, together with an adjacent R group comprise an alkyl or aryl group;
wherein at least one of R₁₃-R₂₁, H, I, J, K or L is a blocking moiety; and
wherein at least one of R₁-R₁₂ comprise said cleavable linkage.

4. An imaging moiety comprising a polymer and a plurality of MRI contrast agents each linked to said polymer by a cleavable linker, and wherein at least one of said MRI contrast agents comprises:
a) at least a first paramagnetic metal ion bound to a first complex, said first complex comprising:
i) a first chelator; and
ii) a blocking moiety covalently attached to said first chelator which binds in at least a first coordination site of said first metal ion and which is capable of interacting with a target substance such that the exchange of water in at least said first coordination site of said first metal ion is increased; and
b) at least a second paramagnetic metal ion bound to a second complex, said second complex comprising:
i) a second chelator; and
ii) a blocking moiety covalently attached to said second chelator which binds in at least a first coordination site of said second metal ion and which is capable of interacting with a target substance such that the exchange of water in at least said first coordination site of said second metal ion is increased.

5. An imaging moiety comprising a polymer and a plurality of MRI contrast agents each linked to said polymer by a cleavable linker, wherein at least one of said MRI contrast agents comprises at least a first MRI duplex moiety, said MRI duplex moiety comprising:
a) a first chelator comprising a first paramagnetic metal ion;
b) a second chelator comprising a second paramagnetic metal ion;
c) a blocking moiety covalently attached to at least one of said first or said second chelators, said blocking moiety providing at least a first coordination atom of each of said first and said second metal ions and which is capable of interacting with a target substance such that the exchange of water in at least a first coordination site in at least one of said metal ions is increased.

6. An imaging moiety comprising a polymer and a plurality of MRI contrast agents each linked to said polymer by a cleavable linker, and wherein at least one of said MRI contrast agents comprises a paramagnetic metal ion bound to a complex, said complex comprising:
a) a chelator; and
b) a blocking moiety covalently attached to said chelator which binds in at least a first coordination site of said metal ion and which is capable of interacting with a target substance such that the exchange of water in at least said first coordination site is increased.

7. The imaging moiety according to any one of claims 1, 2, 3, 4, 5, or 6, wherein said cleavable linkage is an esterase linkage.

8. The imaging moiety according to any one of claims 1, 2, 3, 4, 5, 6, or 7, wherein said MRI agent or said polymer further comprises a targeting moiety.

9. The imaging moiety according to any one of claims 1, 2, 3, 4, 5, 6, 7, or 8, wherein said blocking moiety is a therapeutic blocking moiety.

10. The imaging moiety according to any one of claims 1, 2, 3, 4, 5, 6, 7, 8, or 9, wherein said blocking moiety is a TAAGM.
